(19) United States
(12) Patent Application Publication
(10) Pub. No.: US 2025/0353867 A1
(43) Pub. Date: Nov. 20, 2025

(54) Substituted Pyridine-2,6-Bis(Phenylenephenolate) Complexes with Enhanced Solubility that are Useful as Catalyst Components for Olefin Polymerization

(71) Applicant: EXXONMOBIL CHEMICAL PATENTS INC., Baytown, TX (US)

(72) Inventors: Jo Ann M. Canich, Houston, TX (US); Catherine A. Faler, Houston, TX (US); John R. Hagadorn, Houston, TX (US); Irene C. Cai, Webster, TX (US); Michelle E. Titone, Houston, TX (US); Margaret T. Whalley, Houston, TX (US); Gregory J. Smith-Karahalis, Houston, TX (US)

(21) Appl. No.: 18/862,771

(22) PCT Filed: Apr. 27, 2023
(86) PCT No.: PCT/US2023/066307

§ 371 Date: Nov. 4, 2024

Related U.S. Application Data
(60) Provisional application No. 63/338,169, filed on May 4, 2022.

(51) Int. Cl. C07F 7/00; C08F 10/06

(52) U.S. Cl. CPC C07F 7/00; C08F 10/06

(57) ABSTRACT

Exemplary embodiments of the present technological advancement include pyridine-2,6-bis(phenylenephenolate) complexes that are useful as catalyst components for olefin polymerization and have improved solubility in non-aromatic hydrocarbons (e.g. isohexane). The improved solubility of these complexes was accomplished by the modification of the ligand framework at a specific position that led to improved solubility, but did not adversely affect the performance of the complex when used as a catalyst for olefin polymerizations.

### CROSS REFERENCE TO RELATED APPLICATIONS

This application claims the benefit of and priority to U.S. Provisional Application No. 63/338,169 filed May 4, 2022, the disclosure of which is incorporated herein by reference.

### FIELD

The present disclosure relates to bis(aryl phenolate) Lewis base transition metal complexes, catalyst systems including bis(aryl phenolate) Lewis base transition metal complexes, and polymerization processes to produce polyolefin polymers such as polyethylene based polymers and polypropylene based polymers.

### BACKGROUND

Polyolefins, such as polyethylene, typically have a comonomer, such as hexene, incorporated into the polyethylene backbone. These copolymers provide varying physical properties compared to polyethylene alone and are typically produced in a low pressure reactor, utilizing, for example, solution, slurry, or gas phase polymerization processes. Polymerization may take place in the presence of catalyst systems such as those using a Ziegler-Natta catalyst, a chromium based catalyst, or a metallocene catalyst.

Additionally, pre-catalysts (neutral, unactivated complexes) should be thermally stable at and above ambient temperature, as they are often stored for weeks before being used. The performance of a given catalyst is closely influenced by the reaction conditions, such as the monomer concentrations and temperature. For instance, the solution process, which benefits from being run at temperatures above 120° C., is particularly challenging for catalyst development. At such high reactor temperatures, it is often difficult to maintain high catalyst activity and high molecular weight capability as both attributes quite consistently decline with an increase of reactor temperature. With a wide range of polyolefin products desired, from high density polyethylene (HDPE) to elastomers (e.g., thermoplastic elastomers (TPE); ethylene-propylene-diene (EPDM)), many different catalyst systems may be needed, as it is unlikely that a single catalyst will be able to address all the needs for the production of these various polyolefin products. The strict set of requirements needed for the development and production of new polyolefin products makes the identification of suitable catalysts for a given product and production process a highly challenging endeavor.

Aromatic solvents are typically used to dissolve catalyst components in industrial olefin polymerization processes. However, typically it is challenging to replace aromatic solvents with non-aromatic solvents, such as isohexane, due to poor solubility of catalyst components in non-aromatic solvents.

Further information regarding the general state of the art for non-metallocene olefin polymerization catalysts can be found in Baier, M. C. (2014) “Post-Metallocenes in the Industrial Production of Poly-olefins,” Angew. Chem. Int. Ed., v. 53, pp. 9722-9744, the entire contents of which are hereby incorporated by reference.

Further information regarding complexes can be found in: Goryunov, G. P. et al. (2021) “Rigid Postmetallocene Catalysts for Propylene Polymerization: Ligand Design Prevents the Temperature-Dependent Loss of Stereo- and Regioselectivities,” ACS Catalysis, v. 11(13), pp. 8079-8086; US 2020/0255556; US 2020/0255555; US 2020/0254431; and US 2020/0255553, the entirety of each of which is hereby incorporated by reference.

### SUMMARY

A catalyst compound represented by Formula (I):

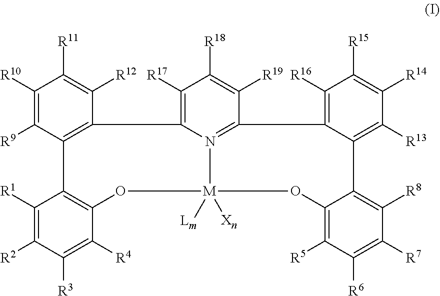

wherein:
M is a group 3, 4, or 5 metal;
L is a Lewis base;
X is an anionic ligand;
n is 1, 2, or 3;
m is 0, 1, or 2;
n+m is not greater than 4;
each of R¹⁰ and R¹⁴ is independently C₄-C₄₀ hydrocarbyl or OR²⁰, where R²⁰ is a C₄-C₄₀ hydrocarbyl;
each of R¹, R², R³, R⁴, R⁵, R⁶, R⁷, and R⁸ is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms; each of R⁹, R¹¹, and R¹² is independently hydrogen, C₁-C₄₀ hydrocarbyl, C₁-C₄₀ substituted hydrocarbyl, a heteroatom or a heteroatom-containing group, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹³, R¹⁵, and R¹⁶ is independently hydrogen, C₁-C₄₀ hydrocarbyl, C₁-C₄₀ substituted hydrocarbyl, a heteroatom or a heteroatom-containing group, or R¹⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₄₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups may be joined together to form a bidentate Lewis base;
an X group may be joined to an L group to form a monoanionic bidentate group; and
any two X groups may be joined together to form a dianionic ligand group.

A homogeneous solution, comprising: an aliphatic hydrocarbon solvent; and at least one complex of Formula (I), with a concentration of the complex being 0.20 wt % or greater (alternatively 0.25 wt % or greater, alternatively 0.30 wt % or greater, alternatively 0.35 wt % or greater, alternatively 0.40 wt % or greater, alternatively 0.50 wt % or greater, alternatively 1.0 wt % or greater, alternatively 2.0 wt % or greater).

A process for the production of a propylene based polymer comprising: polymerizing propylene by contacting the propylene with a catalyst system made from Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

A process for the production of an ethylene based polymer comprising: polymerizing ethylene by contacting the ethylene with the catalyst system made from Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

### DETAILED DESCRIPTION

Exemplary embodiments of the present technological advancement include pyridine-2,6-bis(phenylenephenolate) complexes that are useful as catalyst components for olefin polymerization and have improved solubility in non-aromatic hydrocarbons (e.g. isohexane). The improved solubility of these complexes was accomplished by the modification of the ligand framework at a specific position that led to improved solubility, but did not adversely affect the performance of the complex when used as a catalyst for olefin polymerizations.

For the purposes of the present disclosure, the numbering scheme for the Periodic Table Groups is used as described in Chemical and Engineering News, v. 63(5), pg. 27 (1985). Therefore, a “group 4 metal” is an element from group 4 of the Periodic Table, e.g., Hf, Ti, or Zr.

The following abbreviations may be used herein: Me is methyl, Et is ethyl, Ph is phenyl, tBu is tertiary butyl, MAO is methylalumoxane, NMR is nuclear magnetic resonance, t is time, s is second, h is hour, psi is pounds per square inch, psig is pounds per square inch gauge, equiv is equivalent, RPM is rotation per minute.

The specification describes transition metal complexes. The term complex is used to describe molecules in which an ancillary ligand is coordinated to a central transition metal atom. The ligand is bulky and stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization or oligomerization function using an activator which, without being bound by theory, is believed to create a cation as a result of the removal of an anionic group, often referred to as a leaving group, from the transition metal.

The terms “substituent,” “radical,” “group,” and “moiety” may be used interchangeably.

“Conversion” is the amount of monomer that is converted to polymer product, and is reported as mol % and is calculated based on the polymer yield and the amount of monomer fed into the reactor.

“Catalyst activity” is a measure of how active the catalyst is and is reported as the grams of product polymer (P) produced per millimole of catalyst (cat) used per hour (gP·mmolcat⁻¹·h⁻¹).

The term “heteroatom” refers to any group 13-17 element, excluding carbon. A heteroatom may include B, Si, Ge, Sn, N, P, As, O, S, Se, Te, F, Cl, Br, and I. The term “heteroatom” may include the aforementioned elements with hydrogens attached, such as BH, BH₂, SiH₂, OH, NH, NH₂, etc. The term “substituted heteroatom” describes a heteroatom that has one or more of these hydrogen atoms replaced by a hydrocarbyl or substituted hydrocarbyl group(s).

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring. The term “hydrocarbyl substituted phenyl” means a phenyl group having 1, 2, 3, 4 or 5 hydrogen groups replaced by a hydrocarbyl or substituted hydrocarbyl group. For example, the “hydrocarbyl substituted phenyl” group can be represented by the formula:

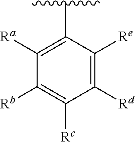

where each of R^{a}, R^{b}, R^{c}, R^{d}, and R^{e} can be independently selected from hydrogen, C₁-C₄₀ hydrocarbyl or C₁-C₄₀ substituted hydrocarbyl, a heteroatom or a heteroatom-containing group (provided that at least one of R^{a}, R^{b}, R^{c}, R^{d}, and R^{e} is not H), or two or more of R^{a}, R^{b}, R^{c}, R^{d}, and R^{e} can be joined together to form a C₄-C₆₂ cyclic or polycyclic hydrocarbyl ring structure, or a combination thereof.

The term “substituted aromatic,” means an aromatic group having 1 or more hydrogen groups replaced by a hydrocarbyl, substituted hydrocarbyl, heteroatom or heteroatom containing group.

The term “substituted phenyl,” mean a phenyl group having 1 or more hydrogen groups replaced by a hydrocarbyl, substituted hydrocarbyl, heteroatom or heteroatom containing group.

The term “substituted carbazole,” means a carbazolyl group having 1 or more hydrogen groups replaced by a hydrocarbyl, substituted hydrocarbyl, heteroatom or heteroatom containing group.

The term “substituted naphthyl,” means a naphthyl group having 1 or more hydrogen groups replaced by a hydrocarbyl, substituted hydrocarbyl, heteroatom or heteroatom containing group.

The term “substituted anthracenyl,” means an anthracenyl group having 1 or more hydrogen groups replaced by a hydrocarbyl, substituted hydrocarbyl, heteroatom or heteroatom containing group.

The term “substituted fluorenyl” means a fluorenyl group having 1 or more hydrogen groups replaced by a hydrocarbyl, substituted hydrocarbyl, heteroatom or heteroatom containing group.

The terms trihydrocarbylsilyl and trihydrocarbylgermyl means a silyl or germyl group bound to three hydrocarbyl groups. Examples of suitable trihydrocarbylsilyl and trihydrocarbylgermyl groups can include trimethylsilyl, trimethylgermyl, triethylsilyl, triethylgermyl, and all isomers of tripropylsilyl, tripropylgermyl, tributylsilyl, tributylgermyl, tripentylsilyl, tripentylgermyl, butyldimethylsilyl, butyldimethygermyl, dimethyloctylsilyl, dimethyloctylgermyl, and the like.

The terms dihydrocarbylamino and dihydrocarbylphosphino mean a nitrogen or phosphorus group bonded to two hydrocarbyl groups. Examples of suitable dihydrocarbylamino and dihydrocarbylphosphino groups can include dimethylamino, dimethylphosphino, diethylamino, diethylphosphino, and all isomers of dipropylamino, dipropylphosphino, dibutylamino, dibutylphosphino, and the like.

The term “substituted adamantanyl” means an adamantanyl group having 1 or more hydrogen groups replaced by a hydrocarbyl, substituted hydrocarbyl, heteroatom or heteroatom containing group.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl (also referred to as a hydrocarbyloxy group). The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxy.

The term “aryl” or “aryl group” means an aromatic ring and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

The term “arylalkyl” means an aryl group where a hydrogen has been replaced with an alkyl or substituted alkyl group. For example, 3,5′-di-tert-butyl-phenyl indenyl is an indene substituted with an arylalkyl group. When an arylalkyl group is a substituent on another group, it is bound to that group via the aryl.

The term “alkylaryl” means an alkyl group where a hydrogen has been replaced with an aryl or substituted aryl group. For example, phenethyl indenyl is an indene substituted with an ethyl group bound to a benzene group. When an alkylaryl group is a substituent on another group, it is bound to that group via the alkyl.

The term “ring atom” means an atom that is part of a cyclic ring structure. By this definition, a benzyl group has six ring atoms and tetrahydrofuran has 5 ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

The terms “hydrocarbyl radical,” “hydrocarbyl group,” or “hydrocarbyl” may be used interchangeably and are defined to mean a group consisting of hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, propyl (such as n-propyl, isopropyl, cyclopropyl), butyl (such as n-butyl, isobutyl, sec-butyl, tert-butyl, cyclobutyl), pentyl (such as iso-amyl, cyclopentyl) hexyl (such as cyclohexyl), octyl (such as cyclooctyl), nonyl, decyl (such as adamantanyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl, and aryl groups, such as phenyl, benzyl, and naphthyl.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

Unless otherwise indicated, as used herein, “high molecular weight” is defined as a number average molecular weight (Mn) value of 100,000 g/mol or more. “Low molecular weight” is defined as an Mn value of less than 100,000 g/mol.

Unless otherwise noted all melting points (Tm) are differential scanning calorimetry (DSC) second melt.

A “catalyst system” is a combination of at least one catalyst compound, at least one activator, an optional coactivator, and an optional support material. The terms “catalyst compound”, “catalyst complex”, “transition metal complex”, “transition metal compound”, “precatalyst compound”, and “precatalyst complex” are used interchangeably. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The transition metal compound may be neutral as in a precatalyst, or a charged species with a counter ion as in an activated catalyst system. For the purposes of the present disclosure and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. A “Lewis base” is a neutrally charged ligand which donates one or more pairs of electrons to a metal ion. Examples of Lewis bases include diethylether, trimethylamine, pyridine, tetrahydrofuran, dimethylsulfide, and triphenylphosphine. The term “heterocyclic Lewis base” refers to Lewis bases that are also heterocycles. Examples of heterocyclic Lewis bases include pyridine, imidazole, thiazole, and furan. The bis(aryl phenolate) Lewis base ligands are tridentate ligands that bind to the metal via two anionic donors (phenolates) and one heterocyclic Lewis base donor (e.g., pyridinyl group). The bis(aryl phenolate)heterocycle ligands are tridentate ligands that bind to the metal via two anionic donors (phenolates) and one heterocyclic Lewis base donor.

The term “continuous” means a system that operates without interruption or cessation. For example a continuous process to produce a polymer would be one where the reactants are continually introduced into one or more reactors and polymer product is continually withdrawn.

### Transition Metal Complexes

In at least one embodiment, the catalyst compound represented by Formula (I) is as follows.

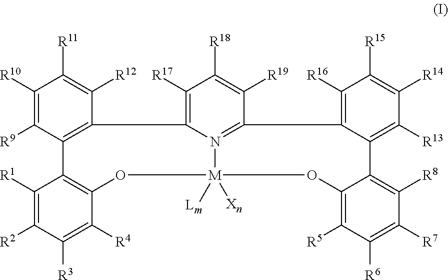

wherein:
M is a group 3, 4, or 5 metal;
L is a Lewis base;
X is an anionic ligand;
n is 1, 2, or 3;
m is 0, 1, or 2;
n+m is not greater than 4;
each of R¹⁰, and R¹⁴ is independently C₄-C₄₀ hydrocarbyl or OR²⁰, where R²⁰ is a C₄-C₄₀ hydrocarbyl;
each of R¹, R², R³, R⁴, R⁵, R⁶, R⁷, and R⁸ is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms; each of R⁹, R¹¹, and R¹² is independently hydrogen, C₁-C₄₀ hydrocarbyl, C₁-C₄₀ substituted hydrocarbyl, a heteroatom or a heteroatom-containing group, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms; each of R¹³, R¹⁵ and R¹⁶ is independently hydrogen, C₁-C₄₀ hydrocarbyl, C₁-C₄₀ substituted hydrocarbyl, a heteroatom or a heteroatom-containing group, or R¹⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₄₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups may be joined together to form a bidentate Lewis base;
an X group may be joined to an L group to form a monoanionic bidentate group; and
any two X groups may be joined together to form a dianionic ligand group.

For example, M of Formula (I) can be a group 3, 4 or 5 metal, such as M can be a group 4 metal. Group 4 metals may include zirconium, titanium, and hafnium. In at least one embodiment, M is zirconium or hafnium.

Each L of Formula (I) can be independently selected from ethers, amines, phosphines, thioethers, esters, such as, for example Et₂O, MeOtBu, Et₃N, PhNMe₂, MePh₂N, tetrahydrofuran, methyl acetate and dimethylsulfide, and each X can be independently selected from methyl, benzyl, trimethylsilyl, methyl(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido. In at least one embodiment, n of Formula (I) is 2 and each X is independently chloro, benzyl or methyl.

Each of R¹, R², R³, R⁴, R⁵, R⁶, R⁷, R⁸ of Formula (I) can be independently selected from hydrogen, C₁-C₄₀ hydrocarbyl, C₁-C₄₀ substituted hydrocarbyl, hydrocarbyloxy, trihydrocarbylsilyl, trihydrocarbylgermyl, dihydrocarbylamino, dihydrocarbylphosphino, or halogen, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms.

In at least one embodiment, one or more of R¹, R², R³, R⁴, R⁵, R⁶, R⁷, R⁸ of Formula (I) is independently selected from hydrogen, methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), substituted hydrocarbyl radicals and all isomers of substituted hydrocarbyl radicals including trimethylsilylpropyl, trimethylsilylmethyl, trimethylsilylethyl, phenyl, or all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl, heteroatom-containing groups including trimethylsilyl, triethylsilyl, methoxy, ethoxy, cyclohexyloxy, trifluoromethyl, dimethylamino, diethylamino, dicyclohexylamino and all isomers of tripropylsilyl, tributylsilyl, tripropylsilyl, trihexylsilyl, triheptylsilyl, trioctylsilyl, dimethyoctylsilyl, butyldimethylsilyl (such as t-butyldimethylsilyl), propoxy, butoxy, pentoxy, hexoxy, heptoxy, octoxy and the like.

For example, R⁴ and R⁵ of Formula (I) can be independently C₁-C₂₀ alkyl, such as R⁴ and R⁵ can be tert-butyl, or adamantanyl. In at least one embodiment, R⁴ and R⁵ are independently selected from unsubstituted phenyl, substituted phenyl, unsubstituted carbazole, substituted carbazole, unsubstituted naphthyl, substituted naphthyl, unsubstituted anthracenyl, substituted anthracenyl, unsubstituted fluorenyl, or substituted fluorenyl, a heteroatom or a heteroatom-containing group, such as R⁴ and R⁵ can be independently unsubstituted phenyl or 3,5-di-tert-butylbenzyl. Furthermore, either (1) R⁴ can be C₁-C₂₀ alkyl (e.g., R⁴ can be tert-butyl) and R⁵ can be an aryl, or (2) R⁵ can be C₁-C₂₀ alkyl (e.g., R⁵ can be tert-butyl) and R⁴ can be an aryl. Alternately, R⁴ and/or R⁵ can be independently a heteroatom, such as R⁴ and R⁵ can be a halogen atom (such as Br, Cl, F, or I). Alternately, R⁴ and/or R⁵ can be independently a silyl group, such as R⁴ and R⁵ can be a trialkylsilyl or triarylsilyl group, where the alkyl is a C₁ to C₃₀ alkyl (such methyl, ethyl, propyl (such as n-propyl, isopropyl, cyclopropyl), butyl (such as n-butyl, isobutyl, sec-butyl, tert-butyl, cyclobutyl), pentyl (such as iso-amyl, cyclopentyl), hexyl (such as cyclohexyl), octyl (such as cyclooctyl), nonyl, decyl (such as adamantanyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl, and the aryl is a C₆ to C₃₀ aryl (such as phenyl, benzyl, and naphthyl).

In some embodiments, R⁴ and R⁵ is independently a C₁-C₄₀ hydrocarbyl, a C₁-C₄₀ substituted hydrocarbyl, more preferably, each R⁴ and R⁵ is independently selected from a tertiary hydrocarbyl groups (such as tert-butyl, tert-pentyl, tert-hexyl, tert-heptyl, tert-octyl, tert-nonyl, tert-decyl, tert-undecyl, tert-dodecyl) and cyclic tertiary hydrocarbyl groups (such as such as 1-methylcyclohexyl, 1-norbornyl, 1-adamantanyl, or substituted 1-adamantanyl).

In some embodiments, R⁴ and R⁵ is independently a C₁-C₄₀ hydrocarbyl, a C₁-C₄₀ substituted hydrocarbyl, more preferably, each of R⁴ and R⁵ is independently a non-aromatic cyclic alkyl group (such as cyclohexyl, cyclooctyl, cyclodecyl, cyclododecyl, adamantanyl, norbornyl, or 1-methylcyclohexyl, or substituted adamantanyl), most preferably a non-aromatic cyclic tertiary alkyl group (such as 1-methylcyclohexyl, 1-adamantanyl, substituted 1-adamantanyl, or 1-norbornyl).

In some embodiments, R⁴ and R⁵ is independently a C₃-C₃₀ heteroatom-containing group including trimethylsilyl, triethylsilyl, and all isomers of tripropylsilyl, tributylsilyl, tripentylsilyl, trihexylsilyl, triheptylsilyl, trioctylsilyl, dimethyoctylsilyl, butyldimethylsilyl, and the like.

The identity of R⁴ and R⁵ can be used to control the molecular weight of the polymer products. For example, when one or both of R⁴ and R⁵ are tert-butyl, the catalyst compound may provide high molecular weight polymers. In contrast, when R⁴, R⁵, or R⁴ and R⁵ are phenyl, the catalyst compound may provide low molecular weight polymers.

In at least one embodiment, each R² and R⁷ of Formula (I) is independently C₁-C₁₀ alkyl, such as R² and R⁷ are independently methyl, ethyl, propyl, butyl, pentyl, hexyl, heptyl, octyl, nonyl, decyl, dimethyl-pentyl, tert-butyl, isopropyl, or isomers thereof.

In at least one embodiment, each R² and R⁷ of Formula (I) is independently a C₃-C₃₀ substituted hydrocarbyl or a C₃-C₃₀ heteroatom-containing group, such as R² and R⁷ are independently trimethylsilyl, triethylsilyl, tripropylsilyl, tributylsilyl, trihexylsilyl, trioctylsilyl, dimethyoctylsilyl, butyldimethylsilyl (including t-butyldimethylsilyl), methyltrimethylsilyl, or isomers thereof.

Each of R¹, R³, R⁶, R⁸, R⁹, R¹¹, R¹², R¹³, R¹⁵, R¹⁶, R¹⁷, R¹⁸, and R¹⁹ of Formula (I) can be independently hydrogen or C₁-C₁₀ alkyl, such as R¹, R³, R⁶, R⁸, R⁹, R¹¹, R¹², R¹³, R¹⁵, R¹⁶, R¹⁷, R¹⁸, and R¹⁹ can be independently hydrogen, methyl, ethyl, propyl, or isopropyl. In at least one embodiment, R¹, R³, R⁶, R⁸, R⁹, R¹¹, R¹², R¹³, R¹⁵, R¹⁶, R¹⁷, R¹⁸, and R¹⁹ are hydrogen. Alternately, each of R¹, R³, R⁶, R⁸, R⁹, R¹¹, R¹², R¹³, R¹⁵, R¹⁶, R¹⁷, R¹⁸, and R¹⁹ of Formula (I) can be independently hydrogen, phenyl, cyclohexyl, fluoro, chloro, methoxy, ethoxy, phenoxy, or trimethylsilyl.

Each of R¹⁰ and R¹⁴ of Formula (I) is independently C₄-C₄₀ hydrocarbyl such as a C₄-C₂₀ alkyl, such as butyl (such as n-butyl, isobutyl, sec-butyl, tert-butyl, cyclobutyl), pentyl (such as n-pentyl, iso-pentyl, iso-amyl, neopentyl, cyclopentyl), hexyl (such as n-hexyl, iso-hexyl, cyclohexyl), heptyl (such as n-heptyl, iso-heptyl and norbornyl) octyl (such as n-octyl, isooctyl, cyclooctyl), nonyl (such as n-nonyl, iso-nonyl), decyl (such as n-decyl, iso-decyl, cyclodecyl, adamantanyl), undecyl (such as n-undecyl, iso-undecy), dodecyl (such as n-dodecyl, iso-dodecyl, cyclododecyl), tridecyl, tetradecyl, pentadecyl, hexadecyl, heptadecyl, octadecyl, nonadecyl, icosyl, and all isomers thereof; or each of R¹⁰ and R¹⁴ of Formula (I) is independently OR²⁰, where R²⁰ is a C₄-C₄₀ hydrocarbyl such as a C₄-C₂₀ hydrocarbyl such as butyl (such as n-butyl, isobutyl, sec-butyl, tert-butyl, cyclobutyl), pentyl (such as n-pentyl, iso-pentyl, iso-amyl, neopentyl, cyclopentyl), hexyl (such as n-hexyl, iso-hexyl, cyclohexyl), heptyl (such as n-heptyl, iso-heptyl and norbornyl) octyl (such as n-octyl, isooctyl, cyclooctyl), nonyl (such as n-nonyl, iso-nonyl), decyl (such as n-decyl, iso-decyl, cyclodecyl, adamantanyl), undecyl (such as n-undecyl, iso-undecy), dodecyl (such as n-dodecyl, iso-dodecyl, cyclododecyl), tridecyl, tetradecyl, pentadecyl, hexadecyl, heptadecyl, octadecyl, nonadecyl, icosyl, and all isomers thereof. In some embodiments, R¹⁰ is a C₄-C₄₀ hydrocarbyl and R¹⁴ is a OR²⁰, where R²⁰ is a C₄-C₄₀ hydrocarbyl. In some embodiments, R¹⁴ is a C₄-C₄₀ hydrocarbyl and R¹⁰ is a OR²⁰, where R²⁰ is a C₄-C₄₀ hydrocarbyl. In some embodiments, R¹⁰ and R¹⁴ are independently a C₄-C₄₀ hydrocarbyl. In some embodiments, R¹⁰ and R¹⁴ are independently OR²⁰, where R²⁰ is a C₄-C₄₀ hydrocarbyl.

In some embodiments R¹⁰ and R¹⁴ are selected from butoxy, pentoxy, hexoxy, heptoxy, octoxy, nonoxy, decoxy, undecoxy, dodecoxy, tridecoxy, tetradecoxy, pentadecoxy, hexadecoxy, heptadecoxy, octadecoxy, nonadecoxy, icosoxy, and isomers thereof. In at least one embodiment, R¹⁰ and R¹⁴ are selected from butoxy, hexoxy, octoxy and dodecoxy.

In some embodiments of Formula (I), R⁴ and R⁵ can be adamantanyl or substituted adamantanyl, R² and R⁷ can be C₁-C₈ hydrocarbyl, and R¹⁰ and R¹⁴ are selected from butoxy, hexoxy, octoxy and dodecoxy.

In some embodiments of Formula (I), R⁴ and R⁵ can be adamantanyl or substituted adamantanyl, R² and R⁷ can be tert-butyl or methyl, and R¹⁰ and R¹⁴ are selected from butoxy, hexoxy, octoxy and dodecoxy.

In at least one embodiment, the catalyst compound is one or more of:

| | |
|---|---|
| 3 | 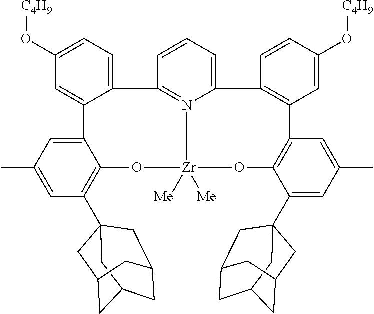 |
| 4 | 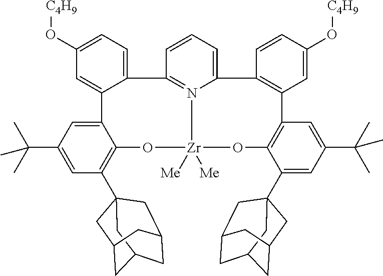 |
| 5 | 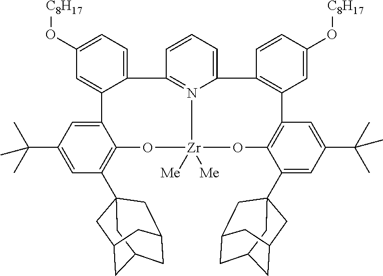 |
| 6 | 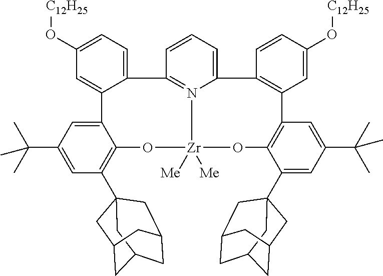 |

In at least one embodiment, one or more different catalyst compounds are present in a catalyst system. One or more different catalyst compounds can be present in the reaction zone where the process(es) described herein occur. The same activator can be used for the transition metal compounds, however, two different activators, such as a non-coordinating anion activator and an alumoxane, can be used in combination.

Further exemplary embodiments of the present technological advancement include the following. Composition of Formula (I), with R⁴ and R⁵ being adamantanyl, R² and R⁷ being C₄-C₄₀ hydrocarbyl, and R¹⁰ and R¹⁴ being OR²⁰, where R²⁰ is a C₄-C₁₂ hydrocarbyl. Composition of Formula (I), with R⁴ and R⁵ being adamantanyl, R² and R⁷ being C₄-C₈ hydrocarbyl, and R¹⁰ and R¹⁴ being OR²⁰, where R²⁰ is a C₄-C₁₂ hydrocarbyl. Composition of Formula (I), with R⁴ and R⁵ being adamantanyl, R² and R⁷ being tert-butyl, and R¹⁰ and R¹⁴ being OR²⁰, where R²⁰ is a C₄-C₁₂ hydrocarbyl. Composition of Formula (I), with the R², R⁷, R¹⁰ and R¹⁴ substituents having a total carbon atom count of 12 carbon atoms or greater, alternatively 14 carbon atoms or greater, alternatively 16 carbon atoms or greater, alternatively 18 carbon atoms or greater. Composition of Formula (I), with the R², R⁷, R¹⁰ and R¹⁴ substituents having a total carbon atom count of 12 carbon atoms or greater, alternatively 14 carbon atoms or greater, alternatively 16 carbon atoms or greater, alternatively 18 carbon atoms or greater, and R⁴ and R⁵ are selected from tert-butyl, adamantanyl, and substituted adamantanyl, wherein an upper limit can be 48 or 50. Composition of Formula (I), with the R², R⁷, R⁴, R⁵, R¹⁰ and R¹⁴ substituents having a total carbon atom count of 32 carbon atoms or greater, alternatively 34 carbon atoms or greater, alternatively 36 carbon atoms or greater, wherein an upper limit can be 72 or up to 80.

Exemplary embodiments of the present technological advancement can also be homogeneous solutions that include an aliphatic hydrocarbon solvent and complexes of Formula (I), with a concentration of the complex 0.15 wt % or greater (alternatively 0.20 wt % or greater, alternatively 0.25 wt % or greater, alternatively 0.30 wt % or greater, alternatively 0.35 wt % or greater, alternatively 0.40 wt % or greater, alternatively 0.50 wt % or greater, alternatively 1.0 wt % or greater, alternatively 2.0 wt % or greater). Without intending to be bound by theory, it is believed that the R¹⁰ and R¹⁴ substituents alone, or in combination with the R⁴ and R⁵ substituents and/or R² and R⁷ substituents, aid in the complexes of Formula (I) solubility in aliphatic solvents.

Another exemplary embodiment of the present technological advancement includes a process for the production of a propylene based polymer comprising: polymerizing propylene and one or more optional C₃-C₄₀ olefins by contacting the propylene and the one or more optional C₃-C₄₀ olefins with a catalyst system including a composition of Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

Another exemplary embodiment of the present technological advancement includes a process for the production of an ethylene based polymer comprising: polymerizing ethylene and one or more optional C₄-C₄₀ olefins by contacting ethylene and the one or more optional C₄-C₄₀ olefins with a catalyst system including a composition of Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene or ethylene based polymer.

### Activators, and Optional Scavengers, Co-Activators, and Chain Transfer Agents

U.S. patent application Ser. No. 16/788,088 (publication number US 2020/0254431) describes activators, optional scavengers, optional co-activators, and optional chain transfer agents useable with the present technological advancement. Particularly useful activators are also described in PCT Application number PCT/US2020/044865 (publication number WO 2021/086467), U.S. patent application Ser. No. 16/394,174 (published as US 2019/0330394) and PCT Application number PCT/US2019/29056 (published as WO 2019/210026) describing non-aromatic-hydrocarbon soluble activator compounds such as N-methyl-4-nonadecyl-N-octadecylanilinium [tetrakis(pentafluorophenyl)borate], N-methyl-4-nonadecyl-N-octadecylanilinium [tetrakis(heptafluoronaphthalenyl)borate], N-methyl-N-octadecyl-4-(octadecyloxy)anilinium [tetrakis(pentafluorophenyl)borate)], N-methyl-N-octadecyl-4-(octadecyloxy)anilinium [tetrakis(heptafluoronaphthalenyl) borate], N,N-di(hydrogenated tallow)methylammonium [tetrakis(pentafluorophenyl)borate], N,N-di(hydrogenated tallow)methylammonium [tetrakis(heptafluoronaphthalenyl)borate], N,N-di(octadecyl)methylammonium [tetrakis(pentafluorophenyl)borate], N,N-di(octadecyl)methylammonium [tetrakis(heptafluoronaphthalenyl)borate], N,N-di(hexadecyl)methylammonium [tetrakis(pentafluorophenyl)borate], N,N-di(hexadecyl)methylammonium [tetrakis(heptafluoronaphthalenyl)borate], N-octadecyl-N-hexadecylmethylammonium [tetrakis(pentafluorophenyl)borate], and N-octadecyl-N-hexadecylmethylammonium [tetrakis(heptafluoronaphthalenyl)borate].

While it is preferred to use an activator that is soluble in a non-aromatic hydrocarbon solvent, activators that are poorly soluble or not soluble in non-aromatic hydrocarbon solvents can be used. When used, these activators can be fed into the reactor via a slurry or as a solid. Particularly useful activators in this class include triphenylcarbenium tetrakis(pentafluorophenyl)borate, triphenylcarbenium tetrakis(perfluoronaphthyl)borate, N,N-dimethylanilinium tetrakis(pentafluorophenyl)borate, N,N-dimethylanilinium tetrakis(perfluoronaphthyl)borate, and the like.

The typical activator-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 1:10.

Particularly useful optional scavengers or co-activators or chain transfer agents include, for example tri-alkyl aluminum such as triisobutylaluminum, tri-n-hexylaluminum, tri-n-octylaluminum, and dialkyl zinc, such as diethyl zinc. Additionally, toluene-free hydrocarbon soluble alumoxanes and modified alumoxanes, including trimethylaluminum “free” alumoxanes may be used.

Moreover, those of ordinary skill in the art are capable of selecting a suitable known activator(s) and optional scavengers or co-activators or chain transfer agents for their particular purpose without undue experimentation. Combinations of multiple activators may be used. Similarly, combinations of multiple optional scavengers or co-activators or chain transfer agents may be used.

### Solvents

While it is possible to use the catalyst components of the present technological advancement with an aromatic solvent, such as toluene, preferably they are absent when using the catalysts components in a polymerization process. Solvents useful for solubilizing the catalyst compound, the activator compound, or for combining the catalyst compound and activator, and/or for introducing the catalyst system or any component thereof into the reactor, and/or for use in the polymerization process include, but are not limited to, aliphatic hydrocarbon solvents, such as butanes, pentanes, hexanes, heptanes, octanes, nonanes, decanes, undecanes, dodecanes, tridecanes, tetradecanes, pentadecanes, hexadecanes, or a combination thereof; preferable solvents can include normal paraffins (such as Norpar™ solvents available from ExxonMobil Chemical Company in Houston, TX), isoparaffin solvents (such as Isopar™ solvents available from ExxonMobil Chemical Company in Houston, TX), non-aromatic cyclic solvents (such as Nappar™ solvents available from ExxonMobil Chemical Company in Houston, TX) and combinations thereof.

Preferably the aliphatic hydrocarbon solvent is selected from C₄ to C₁₀ linear, branched or cyclic alkanes, alternatively from C₅ to C₈ linear, branched or cyclic alkanes.

Preferably the aliphatic hydrocarbon solvent is essentially free of all aromatic solvents. Preferably the solvent is essentially free of toluene. Free of all aromatic solvents, such as toluene, means that the solvent is essentially free of aromatic solvents (e.g. present at zero mol %, alternately present at less than 1 mol %, preferably the polymerization reaction and/or the polymer produced are free of “detectable aromatic hydrocarbon solvent,” such as toluene.

Preferred aliphatic hydrocarbon solvents include isohexane, cyclohexane, methylcyclohexane, pentane, isopentane, heptane, and combinations thereof, in addition to commercially available solvent mixtures such as Nappar6™, and IsoparE™. However, those of ordinary skill in the art can select other suitable non-aromatic hydrocarbon solvents without undue experimentation.

Highly preferred aliphatic hydrocarbon solvents include isohexane, methylcyclohexane, and commercially available solvent mixtures such as Nappar6™, and IsoparE™.

For compound solubility testing, preferred solvents include isohexane and methylcyclohexane.

### Optional Support Materials

In embodiments herein, the catalyst system may include an inert support material. The supported material can be a porous support material, for example, talc, and inorganic oxides. U.S. patent application Ser. No. 16/788,088 (publication number US 2020/0254431) describes optional support materials useable with the present technological advancement. Moreover, those of ordinary skill in the art are capable of selecting a suitable known support for their particular purpose without undue experimentation.

### Polymerization Processes

The present disclosure relates to polymerization processes where monomer (e.g., ethylene; propylene), and optionally one or more comonomer (such as C₂ to C₂₀ alpha olefins, C₄ to C₄₀ cyclic olefins, C₅ to C₂₀ non-conjugated dienes) are contacted with a catalyst system including an activator and at least one catalyst compound, as described above. The catalyst compound and activator may be combined in any order. The catalyst compound and activator may be combined prior to contacting with the monomer. Alternatively, the catalyst compound and activator may be introduced into the polymerization reactor separately, wherein they subsequently react to form the active catalyst.

U.S. patent application Ser. No. 16/788,088 (publication number US 2020/0254431) describes monomers useable with the present technological advancement, and describes polymerization processes useable with the present technological advancement.

Additionally, catalysts that are highly soluble in aliphatic hydrocarbon solvents maybe used as trim catalysts in well-known polymerization processes as described for example in WO 2015/123177 and WO 2020/092587.

### Blends and Films

Polymers made with the present technological advancement can be used to make blends and films as described in U.S. patent application Ser. No. 16/788,088 (publication number US 2020/0254431), without undue experimentation.

### Examples

### General Considerations for Synthesis

The following chemicals may be abbreviated as indicated in either lower case or capital letters: 1,2-dimethoxyethane (dme), ethyl ether (ether), tetrahydrofuran (thf), diatomaceous earth (Celite), methylcyclohexane (MeCy), 1,4-dioxane (dioxane), hexamethyldisiloxane (hmdso), N,N-dimethylformamide (DMF), N-bromosuccinimide (NBS), n-butyl lithium (BuLi). Room temperature is 23° C. unless otherwise noted.

Complexes 1 (dimethylzirconium[2′,2′″-(pyridine-2,6-diyl)bis(3-adamantan-1-yl)-5-methyl-[1,1′-biphenyl]-2-olate)] and 2 (dimethylzirconium[2′,2′″-(pyridine-2,6-diyl)bis(3-adamantan-1-yl)-5-(tert-butyl)-[1,1′-biphenyl]-2-olate)]) (shown below) and 2-(3-adamantan-1-yl)-5-methyl-2-(methoxymethoxy)phenyl)-4,4,5,5-tetramethyl-1,3,2-dioxaborolane were prepared as described in US patent application US 2020/0255553 A1.

| | |
|---|---|
| 1 | 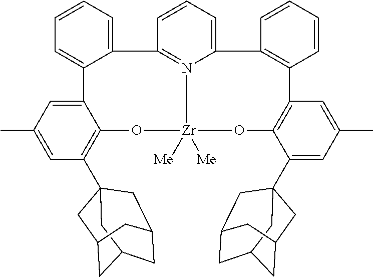 |
| 2 | 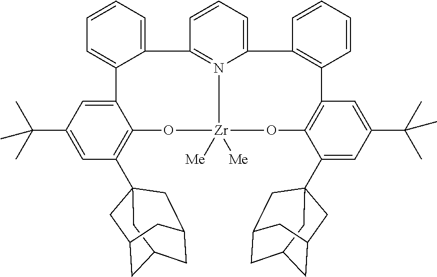 |

All other reagents were purchased from commercial vendors (Sigma Aldrich, Fisher Scientific, Strem Chemical or Oakwood Chemical) and used as received unless otherwise noted. Solvents were sparged with N₂ and dried over 3 Å molecular sieves. All chemical manipulations were performed in a nitrogen environment unless otherwise stated. Flash column chromatography was carried out with Sigma Aldrich silica gel 60 Å (70 Mesh-230 Mesh) using solvent systems specified. All anhydrous solvents were purchased from Fisher Chemical and were degassed and dried over molecular sieves prior to use. Deutrated solvents were purchased from Cambridge Isotope Laboratories and were degassed and dried over molecular sieves prior to use. ¹H NMR spectroscopic data were acquired at 250 MHz, 400 MHz, or 500 MHz using solutions prepared by dissolving approximately 10 mg of a sample in either C₆D₆, CD₂Cl₂, CDCl₃, D₈-toluene, or other deuterated solvent. The chemical shifts (δ) presented are relative to the residual protium in the deuterated solvent at 7.15 ppm, 5.32 ppm, 7.24 ppm, and 2.09 ppm for C₆D₆, CD₂Cl₂, CDCl₃, D₈-toluene, respectively.

### Synthesis of Ligands and Catalysts (or Complexes)

ZrCl₄(ether)₂. Dichloromethane (100 mL) and ZrCl₄ (10.0 g, 42.9 mmol) were combined to form a slurry. Ether (9.54 g, 129 mmol) was added dropwise over 60 minutes. The mixture was stirred for 1 hour. The undissolved solids were allowed to settle, then the supernatant was decanted and filtered through Celite on a fritted disk. The filtrate was evaporated to near dryness to afford a slurry. Isohexane (60 mL) was added to the slurry and the mixture was stirred thoroughly. The resulting off-white solid was collected on a frit, washed with isohexane, and dried under reduced pressure. Yield: 12.5 g, 76.6%.

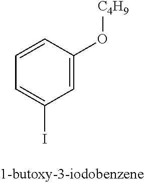

3-iodophenol (15.0 g, 68.2 mmol) and 1-bromobutane (11.2 g, 81.8 mmol) were dissolved in DMF (50 mL). K₂CO₃ (28.5 g, 205 mmol) was added and the mixture was stirred at ambient temperature for 16 hours. The solution was diluted with water and extracted with 3 portions of diethyl ether. Combined organic fractions were rinsed with water and brine, dried with MgSO₄, filtered and concentrated to yield the product as a clear orange liquid. Yield: 15.0 g, 79.7%. ¹H NMR (400 MHz, CDCl₃, δ): 7.27 (m, 2H), 6.98 (t, J=8.0 Hz, 1H), 6.86 (m, 1H), 3.92 (t, J=6.5 Hz, 2H), 1.74 (m, 2H), 1.48 (m, 2H), 0.97 (t, J=7.4 Hz, 3H).

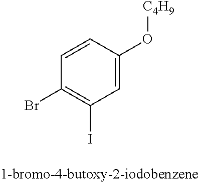

1-butoxy-3-iodobenzene (15.0 g, 54.3 mmol) was dissolved in DMF (50 mL). NBS (10.6 g, 59.8 mmol) was added in portions. The reaction was heated to 80° C. for 4 hours. After cooling to ambient temperature, the solution was diluted with water and extracted with 3 portions of diethyl ether. Combined organic fractions were rinsed with brine, dried with MgSO₄, filtered and concentrated to yield the crude product. The material was recrystallized in hot isohexane to yield the product as a white crystalline solid. Yield: 15.6 g, 80.9%. ¹H NMR (400 MHz, CDCl₃, δ): 7.45 (d, J=8.8 Hz, 1H), 7.38 (d, J=2.9 Hz, 1H), 6.75 (dd, J=8.8, 2.9 Hz, 1H), 3.90 (t, J=6.4 Hz, 2H), 1.73 (m, 2H), 1.47 (m, 2H), 0.97 (t, J=7.4 Hz, 3H).

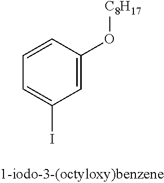

3-iodophenol (8.00 g, 36.4 mmol) and 1-bromooctane (8.43 g, 43.6 mmol) were dissolved in DMF (50 mL). K₂CO₃ (15.2 g, 109 mmol) was added and the mixture was stirred at ambient temperature for 16 hours. The solution was diluted with water and extracted with 3 portions of diethyl ether. Combined organic fractions were rinsed with water and brine, dried with MgSO₄, filtered and concentrated. The crude liquid was purified on SiO₂ using 100% isohexane to yield the product as a colorless oil. Yield: 10.7 g, 88.7%. ¹H NMR (400 MHz, CDCl₃, δ): 7.26 (m, 2H), 6.98 (t, J=8.0 Hz, 1H), 6.86 (d, J=8.3 Hz, 1H), 3.91 (t, J=6.5 Hz, 2H), 1.76 (p, J=6.8 Hz, 2H), 1.44 (m, 2H), 1.29 (m, 8H), 0.89 (t, J=6.5 Hz, 3H).

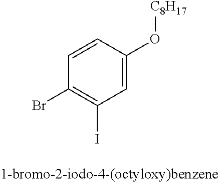

1-iodo-3-(octyloxy)benzene (10.7 g, 32.3 mmol) was dissolved in DMF (75 mL). NBS (6.03 g, 33.9 mmol) was added in portions. The reaction was heated to 80° C. for 4 hours. After cooling to ambient temperature, the solution was diluted with water and extracted with 3 portions of diethyl ether. Combined organic fractions were rinsed with water and brine, dried with MgSO₄, filtered and concentrated to yield the product as clear liquid. Yield: 10.9 g, 82.0%. ¹H NMR (400 MHz, CDCl₃, δ): 7.44 (d, J=8.9 Hz, 1H), 7.38 (d, J=2.8 Hz, 1H), 6.74 (dd, J=8.9, 2.9 Hz, 1H), 3.88 (t, J=6.5 Hz, 2H), 1.75 (p, J=6.8 Hz, 2H), 1.43 (m, 2H), 1.29 (m, 10H), 0.90 (t, J=7.4 Hz, 3H).

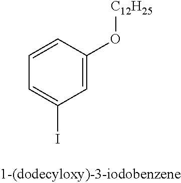

3-iodophenol (8.00 g, 36.4 mmol) and 1-bromododecane (10.9 g, 43.6 mmol) were dissolved in DMF (50 mL). K₂CO₃ (13.3 g, 94.5 mmol) was added and the mixture was stirred at ambient temperature for 16 hours. The solution was diluted with water and extracted with 3 portions of diethyl ether. Combined organic fractions were rinsed with water and brine, dried with MgSO₄, filtered and concentrated. The crude liquid was purified on SiO₂ using 100% isohexane to yield the product as a colorless oil. Yield: 7.34 g, 52.0%. ¹H NMR (400 MHz, CDCl₃, δ): 7.26 (m, 2H), 6.98 (t, J=7.9 Hz, 1H), 6.86 (d, J=8.5 Hz, 1H), 3.91 (t, J=6.5 Hz, 2H), 1.76 (p, J=6.8 Hz, 2H), 1.43 (m, 2H), 1.27 (m, 16H), 0.88 (t, J=6.5 Hz, 3H).

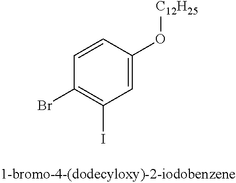

1-(dodecyloxy)-3-iodobenzene (7.34 g, 18.9 mmol) was dissolved in DMF (75 mL). NBS (3.53 g, 19.9 mmol) was added in portions. The reaction was heated to 80° C. for 4 hours. After cooling to ambient temperature, the solution was diluted with water and extracted with 3 portions of diethyl ether. Combined organic fractions were rinsed with water and brine, dried with MgSO₄, filtered and concentrated. The material was recrystallized in hot isohexane to yield the product as a white crystalline solid. Yield: 5.75 g, 65.1%. ¹H NMR (400 MHz, CDCl₃, δ): 7.45 (d, J=8.8 Hz, 1H), 7.38 (d, J=2.8 Hz, 1H), 6.75 (dd, J=8.9, 2.9 Hz, 1H), 3.89 (t, J=6.5 Hz, 2H), 1.75 (p, J=6.8 Hz, 2H), 1.43 (m, 2H), 1.26 (m, 18H), 0.88 (t, J=7.4 Hz, 3H).

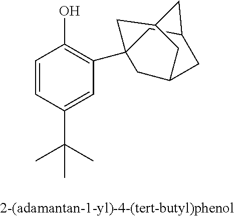 [SMILES: CC(C)(C)c1ccc(O)c(C23CC4CC(CC(C4)C2)C3)c1]

Dichloromethane (120 mL) was added to 4-(tert-butyl)phenol (20.0 g, 133 mmol) and 1-adamantanol (21.3 g, 140 mmol) in a 500 mL round bottom flask. This was stirred until all solids dissolved. To the clear solution was added concentrated sulfuric acid (10.8 mL) dropwise over 20 minutes. The reaction was allowed to stir at room temperature for 4 hours. Water (20 mL) was added and the mixture was brought to neutral pH using 2M sodium hydroxide. The organics were extracted with dichloromethane (3×50 mL), filtered, and dried over magnesium sulfate. The product was purified on SiO₂ using 40-60 vol % ethyl acetate in isohexane. Yield: 20.9 g, 55.1%. ¹H NMR (400 MHz, CDCl₃): δ 7.29 (d, 1H, J=2.5 Hz), 7.11 (dd, 1H, J=8.2, 2.4 Hz), 6.61 (d, 1H, J=8.2 Hz), 2.21-2.16 (m, 6H), 2.15-2.10 (m, 3H), 1.85-1.81 (m, 6H), 1.34 (s, 9H).

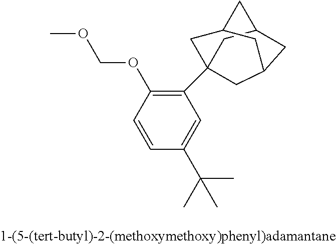 [SMILES: COCOc1ccc(C(C)(C)C)cc1C12CC3CC(CC(C3)C1)C2]

Sodium hydride (2.29 g, 95.3 mmol) was incrementally added to 2-(adamantan-1-yl)-4-(tert-butyl)phenol (20.9 g, 73.3 mmol) in tetrahydrofuran (100 mL). The mixture was stirred overnight. Chloromethyl methyl ether (10.0 g, 125 mmol) was added to the stirring solution, and the reaction mixture was stirred for 4 hours. The reaction was quenched with water (25 mL) and the pH was adjusted to 8-10 using 1M potassium hydroxide. The product was extracted with ethyl ether (3×25 mL), dried over MgSO₄, and concentrated under reduced pressure. Yield: 22.6 g, 94.0%. ¹H NMR (400 MHz, CDCl₃): δ 7.31 (d, 1H, J=2.5 Hz), 7.18 (dd, 1H, J=8.5, 2.5 Hz), 7.06 (d, 1H, J=8.5 Hz), 5.24 (s, 2H), 3.55 (s, 3H), 2.20-2.14 (m, 6H), 2.14-2.08 (m, 3H), 1.84-1.78 (m, 6H), 1.34 (s, 9H).

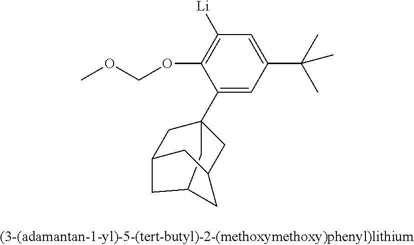

Isohexane (100 mL) was added to 1-(5-(tert-butyl)-2-(methoxymethoxy)phenyl)adamantane (7.00 g, 23.1 mmol) to form a suspension. A hexane solution of butyllithium (2.60 M, 8.90 mL, 23.1 mmol) was added dropwise over 6 minutes. The mixture was stirred for 30 minutes during which time a cloudy yellow solution formed. The mixture was gravity filtered through Celite to afford a clear yellow solution. DME (2.41 mL, 23.1 mmol) was added and the mixture was stirred. Precipitate formed within 30 minutes. The mixture was stirred for an additional couple of hours, then the volatiles were evaporated to near dryness. Isohexane (20 mL) was added and the suspension was cooled to 0° C. The solid was collected on a frit and washed with cold isohexane, then dried under reduced pressure. ¹H NMR data indicated that the product crystallizes with 0.5 molar equivalents of DME. Yield: 4.63 g, 52.7%. ¹H NMR (400 MHz, C₆D₆ with 10% C₄D₄O): δ 7.95 (d, 1H, J=2.4 Hz), 7.31 (d, 1H, J=2.5 Hz), 5.79 (s, 2H), 3.22 (s, 3H), 2.50 (br s, 6H), 2.20 (br s, 3H), 2.01-1.93 (m, 3H), 1.92-1.84 (m, 3H), 1.57 (s, 9H).

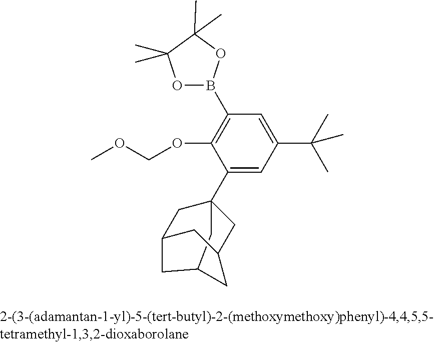 [SMILES: COCOc1c(B2OC(C)(C)C(C)(C)O2)cc(C(C)(C)C)cc1C12CC3CC(CC(C3)C1)C2]

Ether (60 mL) was added to (3-(adamantan-1-yl)-5-(tert-butyl)-2-(methoxymethoxy)phenyl)lithium (4.63 g, 12.2 mmol, cocrystallized with 0.5 DME), and the mixture was cooled to −45° C. To the stirring suspension was quickly added 2-isopropyl-4,4,5,5-tetramethyl-1,3,2-dioxaborolane (2.95 g, 15.9 mmol) in ether (3 mL). The mixture was allowed to slowly warm to ambient temperature over a couple of hours then stirred for an additional hour. The very cloudy colorless mixture was transferred to a separatory funnel containing 60 mL of water. The mixture was shaken until the solids disappeared and the organics were separated. The organics were extracted with water until the aqueous layer was pH neutral. The organics were dried with brine (15 mL), then over MgSO₄. Removal of the volatiles afforded the product as a colorless foam. Yield: 4.95 g, 89.3%. ¹H NMR (400 MHz, CDCl₃): δ 7.52 (d, 1H, J=2.6 Hz), 7.41 (d, 1H, J=2.6 Hz), 5.16 (s, 2H), 3.59 (s, 3H), 2.19-2.13 (m, 6H), 2.11-2.04 (m, 3H), 1.83-1.71 (m, 6H), 1.35 (s, 12H), 1.31 (s, 9H).

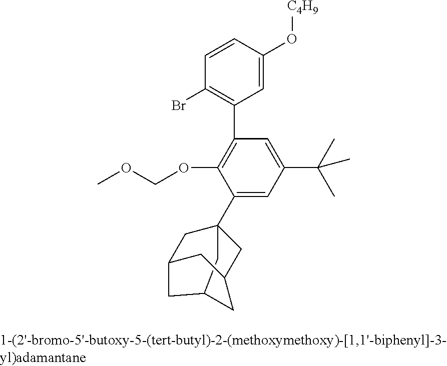

A 250 mL round-bottomed flask was loaded with 2-(3-adamantan-1-yl)-5-(tert-butyl)-2-(methoxymethoxy)phenyl)-4,4,5,5-tetramethyl-1,3,2-dioxaborolane (4.93 g, 10.8 mmol), 1-bromo-4-butoxy-2-iodobenzene (3.85 g, 10.8 mmol), Na₂CO₃ (2.87 g, 27.1 mmol), dioxane (60 mL) and water (30 mL). The mixture was sparged with nitrogen for 50 minutes then solid Pd(PPh₃)₄ (0.627 g, 0.542 mmol) was added. The mixture was sparged for an additional 40 minutes, then stirred rapidly and heated in an oil bath maintained at 100° C. After 20 hours the volatiles were evaporated to near dryness then ether (70 mL) and water (70 mL) were added. The organics were separated and extracted with water until pH neutral. The organics were dried over brine, then evaporated and dried under reduced pressure to afford a pale yellow foam (6.78 g). The crude material contains an impurity(ies) that has low solubility in cold isohexane. Purification was accomplished by the addition of isohexane (50 mL), cooling to −40° C. for an hour, and cold filtration. Stripping of the volatiles afforded product of acceptable purity. ¹H NMR data indicated the presence of 0.3 molar equivalents of isohexane in the product. Yield: 6.24 g, 98.9%). ¹H NMR (400 MHz, CDCl₃): δ 7.55 (d, 1H, J=8.8 Hz), 7.37 (d, 1H, J=2.5 Hz), 7.09 (d, 1H, J=2.5 Hz), 6.97 (d, 1H, J=3.1 Hz), 6.79 (dd, 1H, J=8.8, 3.1 Hz), 4.53 (dd, 2H, J=45.9, 4.5 Hz), 3.97 (t, 2H, J=6.6 Hz), 3.28 (s, 3H), 2.23-2.19 (m, 6H), 2.15-2.09 (m, 3H), 1.86-1.75 (m, 8H), 1.56-1.46 (m, 2H), 1.35 (s, 9H), 0.99 (t, 3H, J=7.4 Hz).

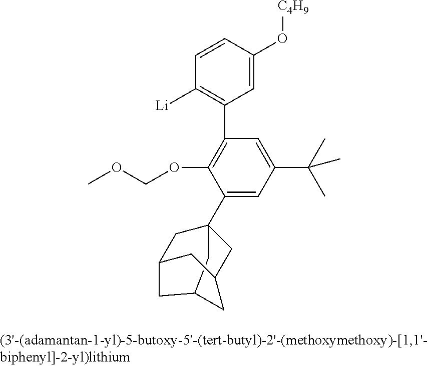

Isohexane (50 mL) was added to 1-(2′-bromo-5′-butoxy-5-(tert-butyl)-2-(methoxymethoxy)-[1,1′-biphenyl]-3-yl)adamantane (6.24 g, 10.7 mmol, with 0.3 equiv. isohexane) to form a clear solution. The mixture was cooled to −50° C. The mixture became very cloudy upon cooling, likely due to some impurity present. A hexane solution of butyllithium (1.66 M, 6.79 mL, 11.3 mmol) was added dropwise over a few minutes. The mixture was allowed to slowly warm to ambient temperature. When the mixture was at −20° C. the mixture was clear and orange tinted. Upon reaching ambient temperature a large amount of precipitate had formed. The solid was collected on a frit and washed with isohexane thoroughly to afford a fine colorless solid that was dried under reduced pressure. The filtration was fairly slow due to the fineness of the solid. Yield: 3.60 g, 69.5%. ¹H NMR (400 MHz, C₆D₆+5% D8-THF): δ 7.61-7.55 (m, 1H), 7.51 (d, 1H, J=2.6 Hz), 7.47 (d, 1H, J=2.5 Hz), 7.30 (d, 1H, J=2.3 Hz), 7.04-6.94 (m, 1H), 4.72 (br s, 2H), 3.89 (t, 2H, J=6.4 Hz), 2.96 (s, 3H), 2.48-2.36 (m, 6H), 2.22-2.13 (m, 3H), 1.95-1.79 (m, 6H), 1.69-1.60 (m, 2H), 1.42-1.29 (m, 11H), 0.80 (t, 3H, J=7.4 Hz).

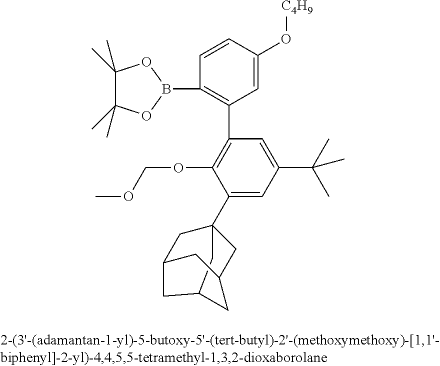

Ether (70 mL) was added to (3′-(adamantan-1-yl)-5-butoxy-5′-(tert-butyl)-2′-(methoxymethoxy)-[1,1′-biphenyl]-2-yl)lithium (3.59 g, 7.44 mmol) to form a clear solution. The mixture was cooled to −45° C. Then 2-isopropoxy-4,4,5,5-tetramethyl-1,3,2-dioxaborolane (1.80 g, 9.67 mmol) was added in one portion. The mixture was allowed to warm slowly in the cold bath for 1 hour. Then the cloudy solution was removed from the cold bath and stirred for an additional hour. The mixture was poured into a separatory funnel and extracted with water until the aqueous layer was pH neutral. The organics were dried with brine, then MgSO₄, then filtered. Evaporation of the solvent under reduced pressure afforded the product as a foam. ¹H NMR indicates acceptable purity. Yield: 4.18 g, 93.2%. ¹H NMR (400 MHz, CDCl₃): δ 7.74 (dd, 1H, J=7.9, 0.7 Hz), 7.29 (d, 1H, J=2.6 Hz), 6.98 (d, 1H, J=2.5 Hz), 6.91-6.88 (m, 2H), 4.51 (dd, 2H, J=50.0, 4.7 Hz), 4.00 (t, 2H, J=6.6 Hz), 3.27 (s, 3H), 2.24-2.19 (m, 6H), 2.14-2.09 (m, 3H), 1.87-1.73 (m, 8H), 1.54-1.43 (m, 2H), 1.32 (s, 9H), 1.14 (d, 12H, J=15.2 Hz), 0.98 (t, 3H, J=7.4 Hz).

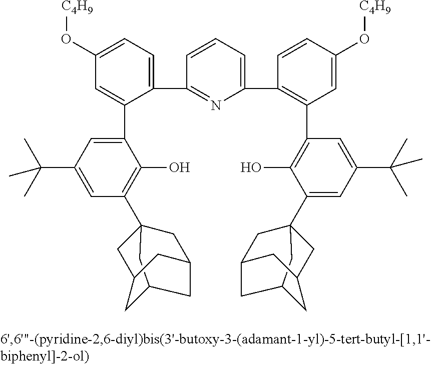

A 250 mL round-bottomed flask was loaded with 2-(3′-(adamantan-1-yl)-5-butoxy-5′-(tert-butyl)-2′-(methoxymethoxy)-[1,1′-biphenyl]-2-yl)-4,4,5,5-tetramethyl-1,3,2-dioxaborolane (4.18 g, 6.94 mmol), 2,6-dibromopyridine (0.789 g, 3.33 mmol), Na₂CO₃ (1.84 g, 17.3 mmol), dioxane (60 mL) and water (30 mL). The mixture was sparged with nitrogen for 50 minutes then solid Pd(PPh₃)₄ (0.401 g, 0.347 mmol) was added. The mixture was sparged for an additional 40 minutes, then stirred rapidly and heated in an oil bath maintained at 100° C. After 14 hours the volatiles were evaporated to near dryness then ether (70 mL) and water (70 mL) were added. The organics were separated and extracted with water until pH neutral. The organics were dried over brine, then evaporated to a residue. Methanol (40 mL), thf (40 mL), and concentrated HCl (4 mL) were added and the mixture was heated to 60° C. After 4.5 hours the mixture was cooled to ambient temperature and the volatiles were evaporated. The residue was dissolved in ether (70 mL) and water (30 mL), and the mixture was transferred to a separatory funnel. The organics were separated and extracted with water until the washes were pH neutral. The organics were then dried with brine, then over MgSO₄, then filtered. The volatiles were removed to afford crude product as a yellow foam (3.57 g). The crude was purified on SiO₂ using 0%-2.5% ethyl acetate in isohexane. Yield: 2.82 g, 90.1%. ¹H NMR (400 MHz, CDCl₃): δ 8.51 (br s, 2H), 7.44 (d, 2H, J=8.7 Hz), 7.14-6.84 (m, 9H), 6.54 (d, 2H, J=2.4 Hz), 4.01 (t, 4H, J=6.4 Hz), 1.98-1.88 (m, 12H), 1.86-1.76 (m, 6H), 1.73-1.64 (m, 12H), 1.58-1.48 (m, 4H), 1.05-0.97 (m, 28H).

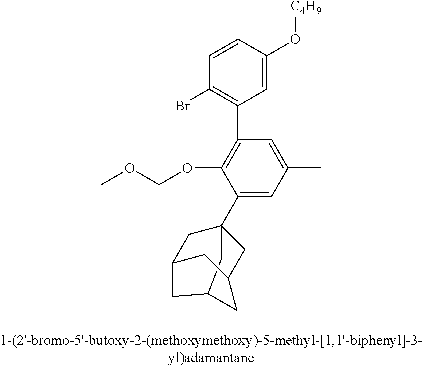

A 250 mL round-bottomed flask was loaded with 2-(3-(adamantan-1-yl)-2-(methoxymethoxy)-5-methylphenyl)-4,4,5,5-tetramethyl-1,3,2-dioxaborolane (3.90 g, 9.46 mmol), 1-bromo-4-butoxy-2-iodobenzene (3.42 g, 9.65 mmol), Na₂CO₃ (2.51 g, 23.6 mmol), dioxane (30 mL) and water (15 mL). The mixture was sparged with nitrogen for 50 minutes then solid Pd(PPh₃)₄ (0.546 g, 0.473 mmol) was added. The mixture was sparged for an additional 40 minutes, then stirred rapidly and heated in an oil bath maintained at 100° C. After 16 hours the volatiles were evaporated to near dryness then ether (70 mL) and water (70 mL) were added. The organics were separated and extracted with water until pH neutral. The organics were dried over brine, then evaporated to a yellow oil. The crude product was purified on SiO₂ using 0%-2 vol % ethyl acetate in isohexane. The product was isolated as a thick oil. Moderate purity. Yield: 4.68 g, 96.4%. ¹H NMR (400 MHz, CDCl₃): δ 7.54 (d, 1H, J=8.8 Hz), 7.16 (d, 1H, J=2.2 Hz), 6.93 (d, 1H, J=3.0 Hz), 6.90 (d, 1H, J=2.3 Hz), 6.79 (dd, 1H, J=8.8, 3.1 Hz), 4.53 (dd, 2H, J=20.6, 4.7 Hz), 3.96 (t, 2H, J=6.55 Hz), 3.27 (s, 3H), 2.35 (s, 3H), 2.21-2.18 (m, 6H), 2.15-2.09 (m, 3H), 1.83-1.79 (m, 6H), 1.56-1.44 (m, 2H), 0.99 (t, 3H, J=7.38 Hz).

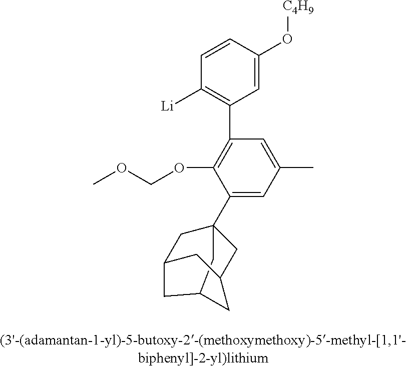

Isohexane (80 mL) was added to 1-(2′-bromo-5′-butoxy-2-(methoxymethoxy)-5-methyl-[1,1′-biphenyl]-3-yl)adamantane (4.66 g, 9.08 mmol) to form a clear solution. The mixture was cooled to −45° C. A hexane solution of BuLi (1.66 M, 5.74 mL, 9.53 mmol) was added dropwise over a few minutes. Upon the initial addition of BuLi the mixture became cloudy, but additional precipitate did not form as the BuLi addition was continued. The mixture was allowed to slowly warm to 15° C. over a few hours during which time a lot of colorless precipitate formed. The mixture was cooled to −45° C. again for about 30 minutes. Then the solid was collected on a fritted disk, washed with cold isohexane (20 mL), and dried under reduced pressure. Product was isolated as a colorless microcrystalline solid. ¹H NMR spectroscopy indicated the presence of 0.5 equiv. of isohexane cocrystallized. Yield: 3.64 g, 82.3%. ¹H NMR (400 MHz, C₆D₆+10% D8-THF): δ 7.81 (d, 1H, J=7.4 Hz), 7.26 (d, 1H, J=2.2 Hz), 7.24 (d, 1H, J=2.3 Hz), 7.12 (d, 1H, J=2.2 Hz), 6.97 (dd, 1H, J=7.5, 2.2 Hz), 4.72 (s, 2H), 3.91 (t, 2H, J=6.4 Hz), 2.92 (s, 3H), 2.38-2.28 (m, 9H), 2.15-2.07 (m, 3H), 1.90-1.74 (m, 6H), 1.71-1.61 (m, 2H), 1.46-1.34 (m, 2H), 0.82 (t, 3H, J=7.5 Hz).

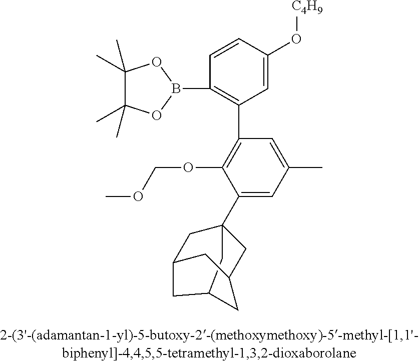

Ether (70 mL) was added to (3′-(adamantan-1-yl)-5-butoxy-2′-(methoxymethoxy)-5′-methyl-[1,1′-biphenyl]-2-yl)lithium (3.64 g, 7.52 mmol) to form a colorless suspension. The mixture was cooled to −45° C. Then 2-isopropoxy-4,4,5,5-tetramethyl-1,3,2-dioxaborolane (1.82 g, 9.78 mmol) was added in one portion. The mixture was allowed to warm slowly in the cold bath. After stirring overnight, the mixture was poured into a separatory funnel and extracted with water until the aqueous layer was pH neutral. The organics were dried with brine, then MgSO₄, then filtered, and dried under reduced pressure to afford a colorless foam. Yield: 4.34 g, 103%. ¹H NMR (400 MHz, CDCl₃): δ 7.71 (d, 1H, J=8.2 Hz), 7.07 (d, 1H, J=2.3 Hz), 6.92-6.82 (m, 3H), 4.53-4.42 (m, 2H), 4.00 (t, 2H, J=6.6 Hz), 3.29 (s, 3H), 2.3 (s, 3H), 2.23-2.18 (m, 6H), 2.14-2.08 (m, 3H), 1.83-1.73 (m, 8H), 1.55-1.44 (m, 2H), 1.17 (d, 12H, J=18.3 Hz), 0.98 (t, 3H, J=7.4 Hz).

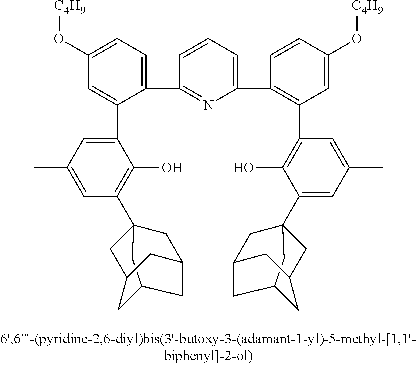

A 200 mL round-bottomed flask was loaded with 2-(3′-(adamantan-1-yl)-5-butoxy-2′-(methoxymethoxy)-5′-methyl-[1,1′-biphenyl]-2-yl)-4,4,5,5-tetramethyl-1,3,2-dioxaborolane (4.34 g, 7.74 mmol), 2,6-dibromopyridine (0.880 g, 3.72 mmol), Na₂CO₃ (2.05 g, 19.4 mmol), dioxane (60 mL) and water (30 mL). The mixture was sparged with nitrogen for 60 minutes then solid Pd(PPh₃)₄ (0.447 g, 0.387 mmol) was added. The mixture was sparged for an additional 40 minutes, then stirred rapidly and heated in an oil bath maintained at 100° C. After 20 hours the volatiles were evaporated to near dryness then ether (80 mL) and water (80 mL) were added. The organics were separated and extracted with water until pH neutral. The organics were dried over brine, then evaporated to a residue. Methanol (40 mL), thf (40 mL), and concentrated HCl (4 mL) were added and the mixture was heated to 60° C. After 4 hours the mixture was cooled to ambient temperature and the volatiles were evaporated. The residue was dissolved in ether (80 mL) and water (50 mL), and the mixture was transferred to a separatory funnel. The organics were separated and extracted with water until the washes were pH neutral. The organics were then dried with brine, then over MgSO₄, then filtered. The volatiles were removed to afford 3.68 g of off-white solid coated with a little orange-colored oily residue. Methylcyclohexane (50 mL) were added and the resulting suspension was stirred for a couple of hours. The undissolved material was collected on a frit, washed with methylcyclohexane (2×5 mL) and dried under reduced pressure to afford a colorless solid (2.53 g). The methylcyclohexane filtrate and washes were loaded onto a SiO₂ column and eluted using 0%-2.5% ethyl acetate in isohexane. Both batches appear to be clean but with a small amount of cocrystallized ether (crop 1 has 0.2 equiv. ether, crop 2 has 0.1 equiv. ether). Yields: crop 1 (solid washed with MeCy): 2.53 g, 78.2% (with 0.2 equiv ether); crop 2 (MeCy filtrate purified on SiO₂): 0.345 g, 10.8% (with 0.1 equiv. ether). ¹H NMR (400 MHz, CDCl₃): δ 8.02 (s, 1H), 7.50 (d, 1H, J=8.5 Hz), 7.44 (d, 1H, J=8.5 Hz), 7.42-7.34 (m, 1H), 7.05-6.96 (m, 2H), 6.94-6.82 (m, 7H), 6.18 (d, 1H, J=2.1 Hz), 4.04-3.96 (m, 4H), 2.26 (s, 3H), 2.0-1.46 (m, 41H), 1.05-0.96 (m, 6H).

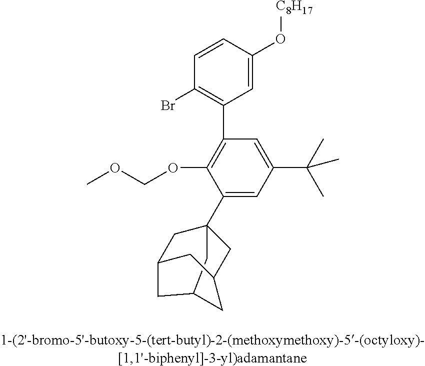

A 20 mL scintillation vial was loaded with 2-(3-(adamantan-1-yl)-5-tert-butyl-2-(methoxymethoxy)-phenyl)-4,4,5,5-tetramethyl-1,3,2-dioxaborolane (2.00 g, 4.40 mmol), 1-bromo-2-iodo-4-(octyloxy)benzene (1.90 g, 4.62 mmol), K₂CO₃ (1.53 g, 11.0 mmol), dioxane (10 mL) and degassed water (10 mL). Solid Pd(PPh₃)₄ (0.254 g, 0.220 mmol) was added last and the reaction was heated to 100° C. After 36 hours, the reaction was cooled to ambient temperature. The solution was diluted with water and extracted with 3 portions of dichloromethane. Combined organic fractions were rinsed with brine, dried with MgSO₄, filtered and concentrated. The crude product was purified on SiO₂ using 10 vol % acetone in isohexane, to yield the desired product as a clear oil. Yield: 2.00 g, 74.3%. ¹H NMR (400 MHz, CDCl₃): δ 7.53 (d, 1H, J=8.7 Hz), 7.34 (s, 1H), 7.06 (s, 1H), 6.94 (d, 1H, J=3.0 Hz), 6.77 (dd, 1H, J=8.8, 3.1 Hz), 4.56 (d, 1H, J=4.5 Hz), 4.44 (d, 1H, J=4.5 Hz), 3.93 (t, 2H, J=6.7 Hz), 3.25 (s, 3H), 2.18 (br s, 6H), 2.14-2.05 (m, 3H), 1.84-1.72 (m, 8H), 1.50-1.39 (m, 2H), 1.38-1.21 (m, 17H), 0.92-0.81 (m, 3H).

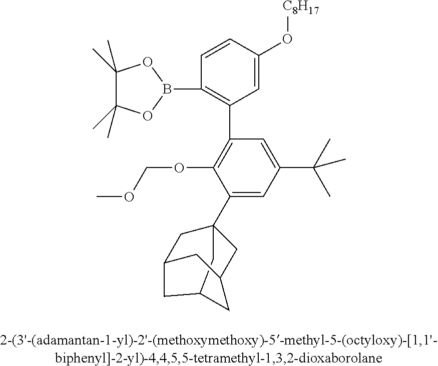

Isohexane (75 mL) was added to 1-(2′-bromo-5-(tert-butyl)-2-(methoxymethoxy)-5′-(octyloxy)-[1,1′-biphenyl]-3-yl)adamantane (2.00 g, 3.27 mmol) to form a clear solution. The mixture was cooled to −45° C. A hexane solution of BuLi (2.50 M, 1.37 mL, 3.43 mmol) was added dropwise over a few minutes. Upon the initial addition of BuLi the mixture became cloudy, but the precipitate dissolved shortly back into the solution. The mixture stirred at −45° C. for 1 hour and then slowly warmed to ambient temperature over 1 hour. The mixture was cooled to −45° C. again for about 30 minutes. Then 2-isopropoxy-4,4,5,5-tetramethyl-1,3,2-dioxaborolane (0.833 g, 4.48 mmol) was added in one portion. The mixture stirred at −45° C. for 1 hour and then slowly warmed to ambient temperature over 1 hour, which produced a yellow slurry. The solution was diluted with water and extracted with 3 portions of ethyl acetate. Combined organic fractions were rinsed with brine, dried with MgSO₄, filtered and concentrated. The crude product was purified on SiO₂ using 5 vol % acetone in isohexane, to yield the desired product as a colorless foam. Yield: 1.10 g, 51%. ¹H NMR (400 MHz, CDCl₃): δ 7.71 (d, 1H, J=8.0 Hz), 6.96 (s, 1H), 6.89-6.82 (m, 2H), 4.54 (d, 1H, J=4.6 Hz), 4.42 (d, 1H, J=4.1 Hz), 3.96 (t, 2H, J=6.6 Hz), 3.25 (s, 3H), 2.19 (br s, 6H), 2.09 (br s, 3H), 1.86-1.71 (m, 8H), 1.49-1.38 (m, 2H), 1.38-1.21 (m, 17H), 1.13 (s, 6H), 1.09 (s, 6H), 0.91-0.81 (m, 3H).

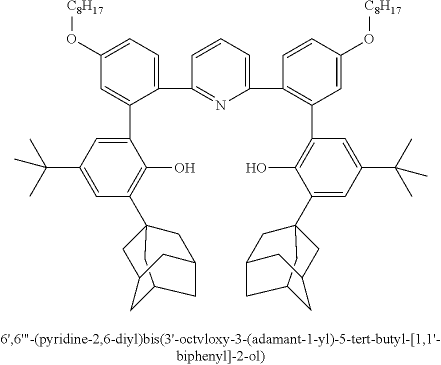

A 250 mL round-bottomed flask was loaded with 2-(3′-(adamantan-1-yl)-2′-(methoxymethoxy)-5′-methyl-5-(octyloxy)-[1,1′-biphenyl]-2-yl)-4,4,5,5-tetramethyl-1,3,2-dioxaborolane (1.10 g, 1.67 mmol), 2,6-dibromopyridine (0.188 g, 0.794 mmol), Na₂CO₃ (0.425 g, 3.97 mmol), dioxane (40 mL) and degassed water (20 mL). Solid Pd(PPh₃)₄ (0.092 g, 0.079 mmol) was added last and the reaction was heated to 100° C. for 16 hours. After cooling to ambient temperature, the solution was diluted with water and extracted with 3 portions of ethyl acetate. Combined organic fractions were rinsed with brine, dried with MgSO₄, filtered and concentrated. Methanol (30 mL), thf (30 mL), and concentrated HCl (2 mL) were added and the mixture was heated to 60° C. After 4 hours, the solution was brought to pH=6 with sat. aqueous sodium bicarbonate solution, concentrated slightly to remove methanol, and extracted with 3 portions of ethyl acetate. Combined organic fractions were rinsed with water and brine, dried with MgSO₄, filtered and concentrated. The crude product was purified on SiO₂ using 5 vol % acetone in isohexane, to yield the desired product as a colorless foam. Yield: 0.150 g, 18.0%. ¹H NMR, isomers integrated together as one (400 MHz, CDCl₃): δ 8.49 (br s, 1H), 7.44-7.27 (m, 3H), 7.14-6.91 (m, 5H), 6.90-6.83 (3H), 6.51 (d, 1H, J=2.4 Hz), 3.97 (t, 4H, J=6.5 Hz), 2.03-1.84 (m, 15H), 1.84-1.73 (m, 6H), 1.73-1.57 (m, 11H), 1.52-1.41 (m, 4H), 1.41-1.25 (m, 18H), 1.04-0.81 (m, 24H).

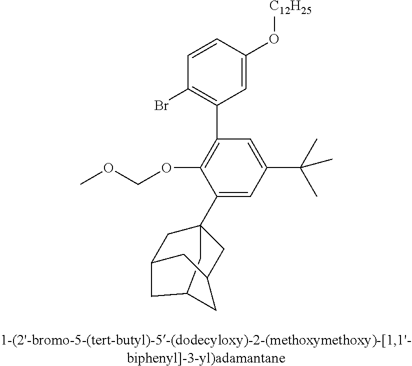

Potassium carbonate (2.30 g, 16.64 mmol) was added to a solution of 2-(3-(1-adamantanyl)-5-(tert-butyl)-2-(methoxymethoxy)phenyl)-4,4,5,5-tetramethyl-1,3,2-dioxaborolane (3.00 g, 6.60 mmol) and 1-bromo-4-(dodecyloxy)-2-iodobenzene (3.70 g, 7.92 mmol) in dioxane (44 mL). Water (17 mL) was added to the stirring suspension. The mixture was sparged with nitrogen for 60 minutes after which tetrakis(triphenylphosphine)palladium(0) (0.38 g, 0.33 mmol) was added. The reaction was heated to 100° C. and stirred for 2 days. The reaction mixture was brought to room temperature and dichloromethane (50 mL) and water (100 mL) were added. The organics were separated and the aqueous layer was extracted with dichloromethane (2×50 mL). Combined organic fractions were dried (MgSO₄), filtered and concentrated in vacuo. The product was purified on SiO₂ using 40%-60 vol % dichloromethane in isohexane. Yield: 3.602 g, 81.7%. ¹H NMR (400 MHz, CDCl₃): δ 7.56 (d, 1H, J=8.8 Hz), 7.37 (d, 1H, J=2.6 Hz), 7.09 (d, 1H, J=2.5 Hz), 6.98 (d, 1H, J=3.0 Hz), 6.80 (dd, 1H, J=8.8, 3.1 Hz), 4.59 (d, 1H, J=4.6 Hz), 4.48 (d, 1H, J=4.5 Hz), 3.96 (t, 2H, J=6.6 Hz), 3.28 (s, 3H), 2.24-2.19 (m, 6H), 2.16-2.10 (m, 3H), 1.87-1.75 (m, 8H), 1.51-1.41 (m, 2H), 1.35 (s, 9H), 1.32-1.25 (m, 16H), 0.91 (t, 3H, J=7.4 Hz).

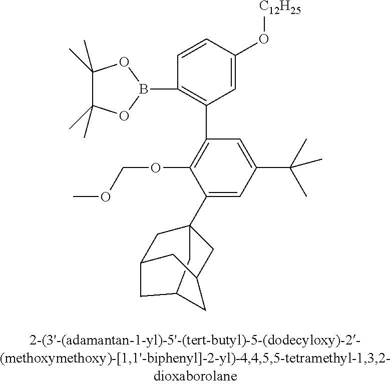

Isohexane (70 mL) was added to 1-(2′-bromo-5-(tert-butyl)-5′-(dodecyloxy)-2-(methoxymethoxy)-[1,1′-biphenyl]-3-yl)adamantane (3.45 g, 5.17 mmol) to form a clear solution. The mixture was cooled to −45° C. A hexane solution of BuLi (2.60 M, 2.02 mL, 5.42 mmol) was added dropwise over a minute. The mixture was stirred for 80 minutes. The mixture was removed from the cold bath and allowed to warm to ambient temperature. The mixture was then cooled back to −45° C. and 2-isopropoxy-4,4,5,5-tetramethyl-1,3,2-dioxaborolane (1.31 g, 7.05 mmol) was added in one portion. The mixture was stirred for an hour then warmed to ambient temperature and stirred for an additional 45 minutes. The suspension was poured into a separatory funnel containing water (75 mL). The mixture was thoroughly shaken then the aqueous layer removed. The organics were extracted with water until the washes were pH neutral. Then the organics were dried over brine, MgSO₄, and filtered. Removal of the volatiles afforded a thick oil (3.61 g). Purified on SiO₂ using 1-3% ethyl acetate in isohexane. Yield: 1.21 g, 32.8%. ¹H NMR (400 MHz, CDCl₃): δ 7.71 (dd, 1H, J=7.9, 0.8 Hz), 7.27 (d, 1H, J=2.7 Hz), 6.96 (d, 1H, J=2.5 Hz), 6.88-6.83 (m, 2H), 4.54 (d, 1H, J=4.6 Hz), 4.42 (d, 1H, J=4.7 Hz), 3.96 (t, 2H, J=6.7 Hz), 3.25 (s, 3H), 2.23-2.16 (m, 6H), 2.13-2.05 (m, 3H), 1.85-1.71 (m, 8H), 1.48-1.38 (m, 2H), 1.34-1.23 (m, 25H), 1.13 (s, 6H), 1.09 (s, 6H), 0.88 (t, 3H, J=6.8 Hz).

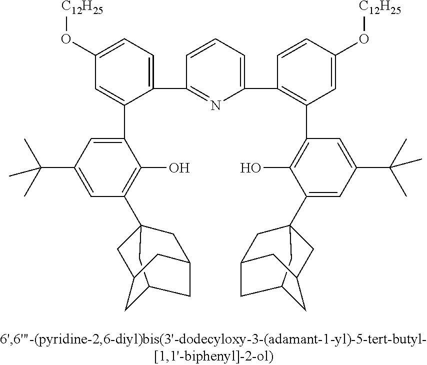

A 200 mL round-bottomed flask was loaded with 2-(3′-(adamantan-1-yl)-5′-(tert-butyl)-5-(dodecyloxy)-2′-(methoxymethoxy)-[1,1′-biphenyl]-2-yl)-4,4,5,5-tetramethyl-1,3,2-dioxaborolane (1.21 g, 1.69 mmol), 2,6-dibromopyridine (0.193 g, 0.812 mmol) Na₂CO₃ (0.449 g, 4.23 mmol), dioxane (40 mL) and water (20 mL). The mixture was sparged with nitrogen for 50 minutes then solid Pd(PPh₃)₄ (0.0978 g, 0.0846 mmol) was added. The mixture was sparged for an additional 40 minutes, then stirred rapidly and heated in an oil bath maintained at 100° C. After 21 hours the volatiles were evaporated to near dryness then ether (70 mL) and water (70 mL) were added. The organics were separated and extracted with water until pH neutral. The organics were dried over brine, then evaporated to a residue. Methanol (20 mL), thf (20 mL), and concentrated HCl (2 mL) were added and the mixture was heated to 60° C. After 4.5 hours the mixture was cooled to ambient temperature and the volatiles were evaporated. The residue was dissolved in ether (75 mL) and water (75 mL), and the mixture was transferred to a separatory funnel. The organics were separated and extracted with water until the washes were pH neutral. The organics were then dried with brine, then over MgSO₄, then filtered. The volatiles were removed to afford crude product. The crude product was purified on SiO₂. Loaded with methylcyclohexane, eluted with 0-2.5% ethyl acetate in isohexane. Product isolated as a white foam. Yield: 0.776 g, 82.0%. ¹H NMR, isomers integrated together as one (400 MHz, CDCl₃): δ 8.50 (br s, 1H), 7.45-7.27 (m, 3H), 7.14-6.91 (m, 5H), 6.90-6.83 (m, 3H), 6.51 (d, 1H, J=2.4 Hz), 3.97 (t, 4H, J=6.4 Hz), 2.22-1.84 (m, 18H), 1.84-1.58 (m, 18H), 1.40-1.15 (m, 38H), 1.03-0.82 (m, 20H).

### Preparation of Transition Metal Complexes

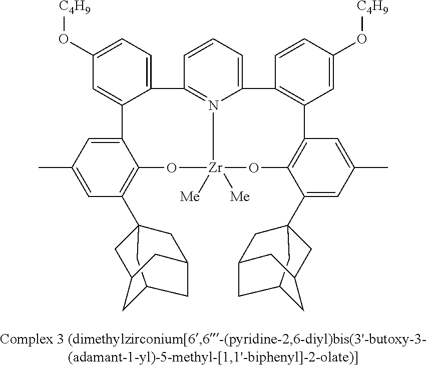

Toluene (15 mL) was added to ZrCl₄(ether)₂ (0.167 g, 0.437 mmol) and 6′,6′″-(pyridine-2,6-diyl)bis(3′-butoxy-3-(adamant-1-yl)-5-methyl-[1,1′-biphenyl]-2-ol) (0.343 g, 0.397 mmol). The mixture was stirred for several minutes then cooled to −20° C. An ether solution of MeMgBr (3.28 M, 0.642 mL, 2.11 mmol) was added in one portion. The mixture was allowed to warm to ambient temperature over 90 minutes then stirred for an additional 15 minutes. The volatiles were removed under reduced pressure. The residue was extracted with methylcyclohexane (20 mL) and filtered through Celite 503. The volatiles were evaporated to about 2 mL, warmed slightly, then isohexane (3 mL) was added. The mixture was cooled to 0° C. for 4 days. Off-white solid was collected, washed with cold isohexane (1 mL), and dried under reduced pressure. Product is cocrystallized with about 0.6 equiv isohexane (by ¹H NMR spectroscopy). Yield: 0.286 g, 70.1%. ¹H NMR (400 MHz, C₆D₆): δ 7.20 (d, 2H, J=2.3 Hz), 7.03 (d, 4H, J=1.5 Hz), 6.91 (t, 2H, J=1.5 Hz), 6.87 (dd, 2H, J=2.3, 0.9 Hz), 6.59-6.50 (m, 3H), 3.63-3.47 (m, 4H), 2.57-2.47 (m, 6H), 2.43-2.33 (m, 6H), 2.24 (s, 6H), 2.21-2.21 (m, 6H), 2.02-1.94 (m, 6H), 1.84-1.76 (m, 6H), 1.52-1.39 (m, 4H), 1.33-1.17 (m, 4H), 0.78 (t, 6H, J=7.3 Hz), 0.23 (s, 6H).

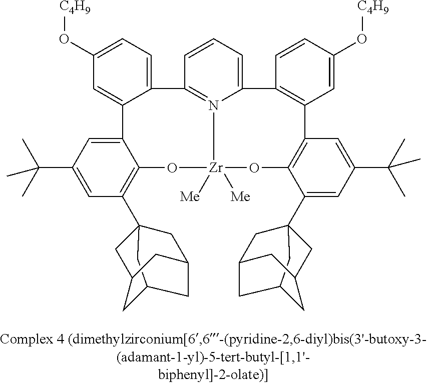

Toluene (80 mL) was added to ZrCl₄(ether)₂ (1.25 g, 3.29 mmol) and 6′,6′″-(pyridine-2,6-diyl)bis(3′-butoxy-3-(adamant-1-yl)-5-tert-butyl-[1,1′-biphenyl]-2-ol) (2.81 g, 2.99 mmol). The mixture was stirred for several minutes then cooled to −20° C. An ether solution of MeMgBr (3.28 M, 4.83 mL, 15.8 mmol) was added in one portion. The mixture was slowly warmed to ambient temperature over a couple of hours then stirred for an additional 30 minutes. The volatiles were removed under reduced pressure. The residue was extracted with methylcyclohexane (80 mL) and filtered through Celite 503. The volatiles were evaporated to near dryness and isohexane (10 mL) was added. The mixture was cooled to 0° C. overnight. The next day a fine solid was suspended in the mixture. The solid was collected on a frit, washed with a cold isohexane (5 mL), and dried under reduced pressure (crop 1). The mother liquor was evaporated to about 4 mL and hmdso (10 mL) was added. Trituration of this mixture afforded a fine solid that was collected on a frit and dried under reduced pressure (crop 2). ¹H NMR indicates that crop 1 has 0.5 equiv. of cocrystallized isohexane. ¹H NMR indicates that crop 2 has 0.5 equiv. of cocrystallized hmdso. Yield (crop 1): 1.94 g, 58.9% (with 0.5 equiv. isohex); (crop 2): 0.486 g, 14.3% (with 0.5 equiv. hmdso). ¹H NMR (400 MHz, C₆D₆): δ 7.57 (d, 2H, J=2.6 Hz), 7.16 (d, 2H, J=2.6 Hz), 7.02-6.91 (m, 6H), 6.56-6.45 (m, 3H), 3.61-3.44 (m, 4H), 2.66-2.56 (m, 6H), 2.53-2.42 (m, 6H), 2.25-2.17 (m, 6H), 2.05-1.95 (m, 6H), 1.86-1.77 (m, 6H), 1.51-1.37 (m, 4H), 1.34 (s, 18H), 1.28-1.16 (m, 4H), 0.77 (t, 6H, J=7.4 Hz), 0.24 (s, 6H).

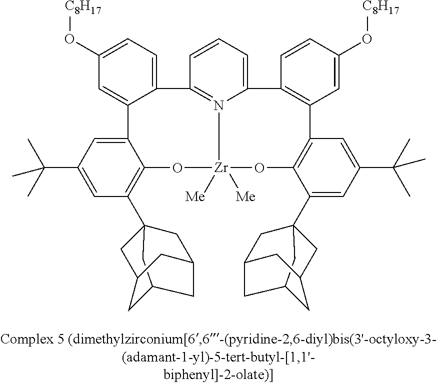

Toluene (20 mL) was added to ZrCl₄(ether)₂ (0.0513 g, 0.135 mmol) and 6′,6′″-(pyridine-2,6-diyl)bis(3′-octyloxy-3-(adamant-1-yl)-5-tert-butyl-[1,1′-biphenyl]-2-ol) (0.128 g, 0.122 mmol). The mixture was stirred for a minute then cooled to −20° C. An ether solution of MeMgBr (3.28 M, 0.198 mL, 0.649 mmol) was added in one portion. The mixture was allowed to warm to ambient temperature over a couple of hours then stirred for an additional 30 minutes. The volatiles were removed under reduced pressure. The residue was extracted with methylcyclohexane (6 mL) and filtered. Evaporated to near dryness and isohexane (1 mL) added to form a solution. Attempts to crystallize the product from either isohexane or hmdso failed. The volatiles were evaporated and dried under reduced pressure to afford an orange-brown foamy semi-solid. ¹H NMR indicates the presence of about 0.7 equiv. of hmdso. Yield: 0.157 g, 99.8%. ¹H NMR (400 MHz, C₆D₆): δ 7.58 (d, 2H, J=2.6 Hz), 7.18 (d, 2H, J=2.5 Hz), 7.06-6.95 (m, 6H), 6.58-6.48 (m, 3H), 3.66-3.48 (m, 4H), 2.68-2.57 (m, 6H), 2.53-2.44 (m, 6H), 2.27-2.19 (m, 6H), 2.07-1.97 (m, 6H), 1.89-1.78 (m, 6H), 1.57-1.46 (m, 4H), 1.40-1.12 (m, 38H), 0.91 (t, 6H, J=7.0 Hz), 0.26 (s, 6H).

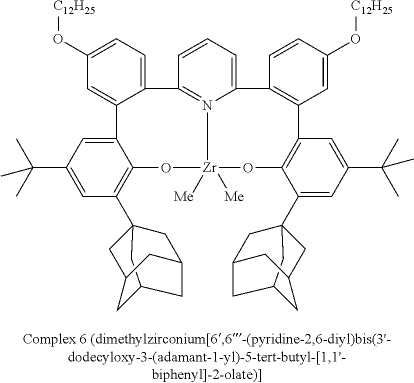

Toluene (40 mL) was added to ZrCl₄(ether)₂ (0.251 g, 0.659 mmol) and 6′,6′″-(pyridine-2,6-diyl)bis(3′-dodecyloxy-3-(adamant-1-yl)-5-tert-butyl-[1,1′-biphenyl]-2-ol) (0.769 g, 0.599 mmol). The mixture was stirred for a minute then cooled to −20° C. An ether solution of MeMgBr (3.28 M, 0.968 mL, 3.18 mmol) was added in one portion. The mixture was allowed to warm to ambient temperature over a couple of hours then stirred for an additional 30 minutes. The volatiles were then removed under reduced pressure to afford a residue. The residue was extracted with toluene (12 mL) and filtered through Celite 503 on a fritted disk. The toluene was evaporated to dryness, then isohexane (3 mL) was added to form a clear brown solution. The solution was cooled to 0° C. overnight, but the solution remained completely homogeneous. The mixture was concentrated to 2 mL and cooled to −20° C. Failed to crystallize after a couple of hours. The volatiles were then evaporated and the residue was dried under reduced pressure. Addition of hmdso (4 mL) and trituration failed to produce a solid. The volatiles were evaporated and the residue was dried under reduced pressure to afford a sticky foamy solid. ¹H NMR spectroscopic data indicates the presence of 0.5 equiv. of hmdso. Yield: 0.845 g, 103%. ¹H NMR (400 MHz, CD₂Cl₂): δ 7.71 (t, 1H, J=7.8 Hz), 7.22 (d, 2H, J=2.6 Hz), 7.11 (d, 2H, J=7.8 Hz), 2.99 (d, 2H, J=8.4 Hz), 6.91-6.83 (m, 3H), 6.80 (d, 2H, J=2.5 Hz), 4.00 (t, 4H, J=6.6 Hz), 2.31-2.21 (m, 6H), 2.19-2.02 (m, 12H), 1.87-1.70 (m, 16H), 1.49-1.20 (m, 54H), 0.92-0.84 (m, 6H), −0.46 (s, 6H).

### Solubility of Complexes

General considerations: Solubility studies were performed using complexes that were isolated as crystalline or microcrystalline solids. Comparative Complex 2 was cocrystallized with 1.4 equivalents of methylcyclohexane. Comparative Complex 1 has no cocrystallized solvent. Complex 3, embodying the present technological advancement, was cocrystallized with 0.6 equivalents of isohexane. Complex 4, embodying the present technological advancement, was cocrystallized with 0.5 equivalents of isohexane. Solvents used were sparged with nitrogen (30-60 minutes) and dried over 3 angstrom molecular sieves. Unless stated otherwise all measurements were performed at ambient temperature (20° C.-25° C.).

General procedure: A tared vial was loaded with a small amount of the complex (actual mass recorded, typically 5-30 mg). Then a small stir bar (8 mm) was added. Solvent was then added and the mixture was stirred rapidly (1000 rpm). If a homogeneous mixture did not form within 30 minutes, then additional solvent was added and mixture was stirred for an additional 30 minutes. This process was repeated until either a clear solution was obtained (no visible solids or murkiness) or the vial was full. As the mixture approached homogeneity (i.e., few remaining solids observed) the volume of the solvent additions was kept small (<1 mL) to minimize the overshooting of the solvent required to achieve homogeneity. The stir bar was then removed and the mass of the mixture was measured. If a clear solution had formed then the solubility of the complex was calculated based on the mass of complex and the amount of solvent added to achieve a homogeneous solution. If the mixture remained heterogeneous (visible solids or murky), then the value reported is given as being “less than” the calculated value. Formulas used to calculate solubility are listed below. Cocrystallized solvent is included in the mass and formula weights of the complexes. The density of isohexane used in the calculations was 0.672 g/ml, and the density of the complex was assumed to be 1.0 g/ml.

Solubility (in wt %)=[100]*[(weight of complex)/(weight of solution)]

Solubility (in mM)=[10⁶]*[(grams of complex)/(formula wt. of complex in g/mol)]/[(grams of solvent)/(density of solvent in g/mL)]

TABLE 1
Solubility of complexes in isohexane at room temperature.

| | Solubility in isohexane | Solubility in isohexane |
|---|---|---|
| Complex | (wt %) | (mM) |
| 1 | <0.08 | <0.6 |
| 2 | 0.081 | 0.52 |
| 3 | 0.168 | 1.10 |
| 4 | 2.55 | 15.7 |

### Polymerization Examples

Solutions of the pre-catalysts were made using toluene (ExxonMobil Chemical-anhydrous, stored under N2) (98%) or isohexane (ExxonMobil Chemical—polymerization grade, and purified as described below). Pre-catalyst solutions were typically 0.25 mmol/L.

Solvents, polymerization grade toluene and/or isohexanes were supplied by ExxonMobil Chemical Co. and are purified by passing through a series of columns: two 500 cc Oxyclear cylinders in series from Labclear (Oakland, Calif.), followed by two 500 cc columns in series packed with dried 3 Å mole sieves (8-12 mesh; Aldrich Chemical Company), and two 500 cc columns in series packed with dried 5 Å mole sieves (8-12 mesh; Aldrich Chemical Company).

Polymerization grade propylene (C₃) was used and further purified by passing it through a series of columns: 2250 cc Oxiclear cylinder from Labclear followed by a 2250 cc column packed with 3 Å mole sieves (8-12 mesh; Aldrich Chemical Company), then two 500 cc columns in series packed with 5 Å mole sieves (8-12 mesh; Aldrich Chemical Company), then a 500 cc column packed with Selexsorb CD (BASF), and finally a 500 cc column packed with Selexsorb COS (BASF).

Activation of the pre-catalysts was either by dimethylanilinium tetrakisperfluorophenylborate (Boulder Scientific or Albemarle Corp; Act ID=A) or (hydrogenated tallow alkyl)methylammonium tetrakis(pentafluorophenyl)borate supplied as a 10 wt % solution in methylcyclohexane (Boulder Scientific; Act ID=B). Activators were typically used as a 0.25 mmol/L solution in toluene or isohexane.

Tri-n-octylaluminum (TnOAl or TNOA, Neat, AkzoNobel) was also used as a scavenger prior to introduction of the activator and pre-catalyst into the reactor. TNOA was typically used as a 5 mmol/L solution in toluene or isohexane.

### Reactor Description and Preparation:

Polymerizations were conducted in an inert atmosphere (N2) drybox using autoclaves equipped with an external heater for temperature control, glass inserts (internal volume of 22.5 mL), septum inlets, regulated supply of nitrogen and propylene, and equipped with disposable PEEK mechanical stirrers (800 RPM). The autoclaves were prepared by purging with dry nitrogen at 110° C. or 115° C. for 5 hours and then at 25° C. for 5 hours.

### Propylene Polymerization (PP):

The reactor was prepared as described above, then heated to 40° C., and then purged with propylene gas at atmospheric pressure. Toluene or isohexanes, liquid propylene (1.0 mL) and scavenger (TNOA, 0.5 μmol) were added via syringe. The reactor was then brought to process temperature (70° C. or 100° C.) while stirring at 800 RPM. The activator solution, followed by the pre-catalyst solution, were injected via syringe to the reactor at process conditions. Reactor temperature was monitored and typically maintained within +/−1° C. Polymerizations were halted by addition of approximately 50 psi compressed dry air gas mixture to the autoclaves for approximately 30 seconds. The polymerizations were quenched based on a predetermined pressure loss (maximum quench value) or for a maximum of 30 minutes. The reactors were cooled and vented. The polymers were isolated after the solvent was removed in-vacuo. The actual quench time (s) is reported as quench time (s). Yields reported include total weight of polymer and residual catalyst. Catalyst activity is reported as grams of polymer per mmol transition metal compound per hour of reaction time (g/mmol·hr). Propylene homopolymerization examples are reported in Table 2 with additional characterization in Table 3.

### Polymer Characterization

For analytical testing, polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw), number average molecular weight (Mn) and z average molecular weight (Mz)) and molecular weight distribution (MWD=Mw/Mn), which is also sometimes referred to as the polydispersity (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5,000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in Tables 2 under the headings Mn, Mw, Mz and PDI as defined above.

Differential Scanning Calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minute and then cooled at a rate of 50° C./minute. Melting points were collected during the heating period. The results are reported in the Tables 2 under the heading, Tm (° C.).

¹³C NMR spectroscopy was used to characterize some polypropylene polymer samples produced in experiments collected in Table 2. This data is collected in Table 3. Unless otherwise indicated the polymer samples for ¹³C NMR spectroscopy were dissolved in d₂-1,1,2,2-tetrachloroethane and the samples were recorded at 125° C. using a NMR spectrometer with a ¹³C NMR frequency of 150 MHz. Polymer resonance peaks are referenced to mmmm=21.8 ppm. Calculations involved in the characterization of polymers by NMR follow the work of F. A. Bovey in “Polymer Conformation and Configuration” Academic Press, New York 1969 and J. Randall in “Polymer Sequence Determination, Carbon-13 NMR Method”, Academic Press, New York, 1977.

The stereodefects measured as “stereo defects/10,000 monomer units” are calculated from the sum of the intensities of mmrr, mmrm+rrmr, and rmrm resonance peaks times 5,000. The intensities used in the calculations are normalized to the total number of monomers in the sample. Methods for measuring 2,1 regio defects/10,000 monomers and 1,3 regio defects/10,000 monomers follow standard methods. Additional references include Grassi, A. et. al. Macromolecules, 1988, v. 21, pp. 617-622 and Busico et. al. Macromolecules, 1994, v. 27, pp. 7538-7543. The average meso run length=10000/[(stereo defects/10000 C)+(2,1-regio defects/10000 C)+(1,3-regio-defects/10000 C)].

Polymerization results are collected in Tables 2. “Ex #” stands for example number. Example numbers starting with a “C” are comparative examples. “Cat ID” identifies the pre-catalyst used in the experiment. Corresponding numbers identifying the pre-catalyst (also referred to as pre-catalyst, catalyst, complex or compound) are located in the synthetic experimental section. T (° C.) is the polymerization temperature which was typically maintained within +/−1° C. “Yield” is polymer yield, and is not corrected for catalyst residue. “Quench time (s)” is the actual duration of the polymerization run in seconds. For propylene homopolymerization runs, quench value indicates the maximum set pressure loss (conversion) of propylene during the polymerization. Activity is reported at grams polymer per mmol of catalyst per hour.

Standard polymerization conditions include 0.015 μmol catalyst complex, 1.1 equivalence of activator, 0.5 μmol TNOA scavenger, 1.0 ml propylene, 4.1 ml total solvent, with quench value at 8 psi pressure loss, or a maximum reaction time of 30 minutes. Activator A is N,N-dimethylanilinium tetrakis(pentafluorophenyl)borate activator and activator B is (hydrogenated tallow alkyl)methylammonium tetrakis(pentafluorophenyl)borate. When activator A was used, both the pre-catalyst and activator solutions were in toluene. When activator B was used, both pre-catalyst and activator solutions were in isohexane. Small amounts of methylcyclohexane (MCH) result from activator B being supplied by the manufacturer as a 10 wt % solution in methylcyclohexane.

TABLE 2
Propylene Polymerization

| | | | | Iso- | | | | |
|---|---|---|---|---|---|---|---|---|
| | Cat | Act | MCH | hexane | Toluene | | quench | |
| Ex# | ID | ID | (μL) | (μL) | (μL) | T (° C.) | time (s) | yield (g) |
| 1 | 3 | A | 0 | 3974 | 126 | 70 | 18 | 0.3603 |
| 2 | 3 | A | 0 | 3974 | 126 | 70 | 33 | 0.3833 |
| 3 | 3 | A | 0 | 3974 | 126 | 70 | 14 | 0.3505 |
| 4 | 3 | A | 0 | 3974 | 126 | 100 | 35 | 0.2406 |
| 5 | 3 | A | 0 | 3974 | 126 | 100 | 14 | 0.2426 |
| 6 | 3 | A | 0 | 3974 | 126 | 100 | 18 | 0.2859 |
| 7 | 3 | B | 0.23 | 4100 | 0 | 70 | 84 | 0.3189 |
| 8 | 3 | B | 0.23 | 4100 | 0 | 70 | 56 | 0.2939 |
| 9 | 3 | B | 0.23 | 4100 | 0 | 70 | 28 | 0.1864 |
| 10 | 3 | B | 0.23 | 4100 | 0 | 100 | 44 | 0.1344 |
| 11 | 3 | B | 0.23 | 4100 | 0 | 100 | 36 | 0.1965 |
| 12 | 3 | B | 0.23 | 4100 | 0 | 100 | 37 | 0.1898 |
| 13 | 4 | A | 0 | 3974 | 126 | 70 | 9 | 0.3121 |
| 14 | 4 | A | 0 | 3974 | 126 | 70 | 45 | 0.3781 |
| 15 | 4 | A | 0 | 3974 | 126 | 70 | 6 | 0.347 |
| 16 | 4 | A | 0 | 3974 | 126 | 100 | 32 | 0.3245 |
| 17 | 4 | A | 0 | 3974 | 126 | 100 | 30 | 0.3224 |
| 18 | 4 | A | 0 | 3974 | 126 | 100 | 12 | 0.2517 |
| 19 | 4 | B | 0.23 | 4100 | 0 | 70 | 22 | 0.3246 |
| 20 | 4 | B | 0.23 | 4100 | 0 | 70 | 18 | 0.345 |
| 21 | 4 | B | 0.23 | 4100 | 0 | 70 | 19 | 0.1213 |
| 22 | 4 | B | 0.23 | 4100 | 0 | 100 | 21 | 0.2142 |
| 23 | 4 | B | 0.23 | 4100 | 0 | 100 | 20 | 0.2199 |
| 24 | 4 | B | 0.23 | 4100 | 0 | 100 | 51 | 0.214 |
| 25 | 5 | A | 0 | 3974 | 126 | 70 | 18 | 0.3347 |
| 26 | 5 | A | 0 | 3974 | 126 | 70 | 9 | 0.3566 |
| 27 | 5 | A | 0 | 3974 | 126 | 70 | 7 | 0.3558 |
| 28 | 5 | A | 0 | 3974 | 126 | 100 | 19 | 0.2673 |
| 29 | 5 | A | 0 | 3974 | 126 | 100 | 33 | 0.3188 |
| 30 | 5 | A | 0 | 3974 | 126 | 100 | 25 | 0.2699 |
| 31 | 5 | B | 0.23 | 4100 | 0 | 70 | 14 | 0.3883 |
| 32 | 5 | B | 0.23 | 4100 | 0 | 70 | 15 | 0.3653 |
| 33 | 5 | B | 0.23 | 4100 | 0 | 70 | 13 | 0.3068 |
| 34 | 5 | B | 0.23 | 4100 | 0 | 100 | 27 | 0.3038 |
| 35 | 5 | B | 0.23 | 4100 | 0 | 100 | 39 | 0.2881 |
| 36 | 5 | B | 0.23 | 4100 | 0 | 100 | 25 | 0.2679 |
| 37 | 6 | A | 0 | 3974 | 126 | 70 | 33 | 0.3217 |
| 38 | 6 | A | 0 | 3974 | 126 | 70 | 17 | 0.3232 |
| 39 | 6 | A | 0 | 3974 | 126 | 70 | 17 | 0.4049 |
| 40 | 6 | A | 0 | 3974 | 126 | 100 | 62 | 0.313 |
| 41 | 6 | A | 0 | 3974 | 126 | 100 | 39 | 0.3312 |
| 42 | 6 | A | 0 | 3974 | 126 | 100 | 14 | 0.2757 |
| 43 | 6 | B | 0.23 | 4100 | 0 | 70 | 51 | 0.3641 |
| 44 | 6 | B | 0.23 | 4100 | 0 | 70 | 43 | 0.3476 |
| 45 | 6 | B | 0.23 | 4100 | 0 | 70 | 37 | 0.2874 |
| 46 | 6 | B | 0.23 | 4100 | 0 | 100 | 50 | 0.2472 |
| 47 | 6 | B | 0.23 | 4100 | 0 | 100 | 40 | 0.1953 |
| 48 | 6 | B | 0.23 | 4100 | 0 | 100 | 54 | 0.2053 |
| C-1 | 1 | A | 0 | 3895 | 205 | 70 | 18 | 0.4025 |
| C-2 | 1 | A | 0 | 3895 | 205 | 70 | 12 | 0.3899 |
| C-3 | 1 | A | 0 | 3895 | 205 | 70 | 9 | 0.4117 |
| C-4 | 1 | A | 0 | 3874 | 226 | 70 | 15 | 0.3543 |
| C-5 | 1 | A | 0 | 3874 | 226 | 70 | 13 | 0.4127 |
| C-6 | 1 | A | 0 | 3874 | 226 | 70 | 14 | 0.4037 |
| C-7 | 1 | A | 0 | 3895 | 205 | 100 | 19 | 0.2373 |
| C-8 | 1 | A | 0 | 3895 | 205 | 100 | 12 | 0.3262 |
| C-9 | 1 | A | 0 | 3874 | 226 | 100 | 16 | 0.2621 |
| C-10 | 1 | A | 0 | 3874 | 226 | 100 | 17 | 0.3151 |
| C-11 | 1 | A | 0 | 3874 | 226 | 100 | 20 | 0.2204 |
| C-12 | 2 | A | 0 | 3974 | 126 | 70 | 17 | 0.3777 |
| C-13 | 2 | A | 0 | 3974 | 126 | 70 | 22 | 0.431 |
| C-14 | 2 | A | 0 | 3974 | 126 | 70 | 10 | 0.4143 |
| C-15 | 2 | A | 0 | 3974 | 126 | 100 | 19 | 0.2842 |
| C-16 | 2 | A | 0 | 3974 | 126 | 100 | 21 | 0.3363 |
| C-17 | 2 | A | 0 | 3974 | 126 | 100 | 8 | 0.2458 |
| C-18 | 2 | B | 0.23 | 4100 | 0 | 70 | 41 | 0.3535 |
| C-19 | 2 | B | 0.23 | 4100 | 0 | 70 | 20 | 0.3501 |
| C-20 | 2 | B | 0.23 | 4100 | 0 | 70 | 22 | 0.2818 |
| C-21 | 2 | B | 0.23 | 4100 | 0 | 100 | 24 | 0.2345 |
| C-22 | 2 | B | 0.23 | 4100 | 0 | 100 | 22 | 0.2459 |
| C-23 | 2 | B | 0.23 | 4100 | 0 | 100 | 31 | 0.2874 |

| | Activity (g | | | | | |
|---|---|---|---|---|---|---|
| Ex# | P/mmol cat · hr) | Mn | Mw | Mz | PDI | Tm (° C.) |
| 1 | 4,804,000 | 108,986 | 427,674 | 1,385,760 | 3.92 | 148.2 |
| 2 | 2,787,636 | 125,644 | 521,527 | 1,712,187 | 4.15 | 149.5 |
| 3 | 6,008,571 | 107,119 | 470,910 | 1,737,099 | 4.40 | 148.6 |
| 4 | 1,649,829 | 71,036 | 184,640 | 590,420 | 2.60 | 148.2 |
| 5 | 4,158,857 | 29,740 | 124,742 | 473,840 | 4.19 | 147.0 |
| 6 | 3,812,000 | 44,055 | 161,140 | 546,516 | 3.66 | 146.7 |
| 7 | 911,143 | 318,473 | 767,425 | 2,208,115 | 2.41 | 150.2 |
| 8 | 1,259,571 | 323,218 | 779,616 | 2,130,771 | 2.41 | 151.3 |
| 9 | 1,597,714 | 236,217 | 643,752 | 1,737,362 | 2.73 | 151.3 |
| 10 | 733,091 | 122,758 | 267,768 | 791,467 | 2.18 | 149.1 |
| 11 | 1,310,000 | 92,912 | 217,774 | 634,922 | 2.34 | 148.0 |
| 12 | 1,231,135 | 79,702 | 215,447 | 757,794 | 2.70 | 148.3 |
| 13 | 8,322,667 | 82,148 | 527,911 | 1,929,222 | 6.43 | 149.1 |
| 14 | 2,016,533 | 116,098 | 530,228 | 1,907,222 | 4.57 | 148.8 |
| 15 | 13,880,000 | 131,448 | 597,556 | 2,702,021 | 4.55 | 149.1 |
| 16 | 2,433,750 | 34,155 | 125,685 | 531,179 | 3.68 | 146.6 |
| 17 | 2,579,200 | 26,236 | 106,937 | 546,840 | 4.08 | 145.5 |
| 18 | 5,034,000 | 23,254 | 138,983 | 700,886 | 5.98 | 146.1 |
| 19 | 3,541,091 | 130,332 | 651,921 | 2,527,310 | 5.00 | 150.1 |
| 20 | 4,600,000 | 157,010 | 671,059 | 2,483,960 | 4.27 | 148.9 |
| 21 | 1,532,211 | 90,425 | 571,891 | 2,713,173 | 6.32 | 150.1 |
| 22 | 2,448,000 | 51,361 | 182,571 | 730,324 | 3.55 | 149.1 |
| 23 | 2,638,800 | 49,435 | 183,494 | 741,999 | 3.71 | 148.7 |
| 24 | 1,007,059 | 97,909 | 237,178 | 709,632 | 2.42 | 150.6 |
| 25 | 4,462,667 | 76,768 | 481,164 | 1,996,697 | 6.27 | 148.1 |
| 26 | 9,509,333 | 115,689 | 671,639 | 3,043,119 | 5.81 | 148.4 |
| 27 | 12,198,857 | 117,079 | 643,644 | 2,734,257 | 5.50 | 149.7 |
| 28 | 3,376,421 | 32,215 | 119,677 | 456,895 | 3.71 | 146.7 |
| 29 | 2,318,545 | 25,907 | 127,432 | 580,834 | 4.92 | 146.2 |
| 30 | 2,591,040 | 48,140 | 174,938 | 725,922 | 3.63 | 149.0 |
| 31 | 6,656,571 | 103,080 | 606,796 | 2,291,886 | 5.89 | 149.9 |
| 32 | 5,844,800 | 110,701 | 700,562 | 3,022,376 | 6.33 | 150.0 |
| 33 | 5,664,000 | 120,725 | 686,352 | 2,985,879 | 5.69 | 149.5 |
| 34 | 2,700,444 | 33,278 | 173,437 | 869,948 | 5.21 | 149.1 |
| 35 | 1,772,923 | 52,719 | 191,283 | 922,828 | 3.63 | 148.6 |
| 36 | 2,571,840 | 37,890 | 178,657 | 824,515 | 4.72 | 147.9 |
| 37 | 2,339,636 | 85,762 | 463,647 | 1,944,403 | 5.41 | 149.8 |
| 38 | 4,562,824 | 163,307 | 551,216 | 1,932,961 | 3.38 | 151.6 |
| 39 | 5,716,235 | 87,683 | 534,922 | 2,186,553 | 6.10 | 148.8 |
| 40 | 1,211,613 | 53,305 | 150,810 | 591,243 | 2.83 | 148.6 |
| 41 | 2,038,154 | 21,894 | 104,338 | 555,312 | 4.77 | 147.6 |
| 42 | 4,726,286 | 38,394 | 164,705 | 786,643 | 4.29 | 148.6 |
| 43 | 1,713,412 | 230,798 | 774,156 | 2,773,358 | 3.35 | 152.7 |
| 44 | 1,940,093 | 239,967 | 779,453 | 2,559,430 | 3.25 | 149.8 |
| 45 | 1,864,216 | 263,483 | 783,245 | 2,581,781 | 2.97 | 151.0 |
| 46 | 1,186,560 | 88,054 | 205,446 | 599,875 | 2.33 | 149.5 |
| 47 | 1,171,800 | 113,092 | 221,076 | 564,454 | 1.95 | 151.1 |
| 48 | 912,444 | 56,432 | 178,338 | 683,839 | 3.16 | 149.8 |
| C-1 | 3,220,000 | 49,716 | 337,334 | 1,245,032 | 6.79 | 144.9 |
| C-2 | 4,678,800 | 30,862 | 378,892 | 1,226,503 | 12.3 | 145.9 |
| C-3 | 6,587,200 | 47,258 | 341,708 | 1,130,024 | 7.23 | 146.4 |
| C-4 | 5,668,800 | 57,753 | 372,797 | 1,464,190 | 6.46 | 147.5 |
| C-5 | 7,619,077 | 64,376 | 502,821 | 2,141,863 | 7.81 | 147.3 |
| C-6 | 6,920,571 | 67,290 | 428,075 | 1,753,319 | 6.36 | 148.1 |
| C-7 | 1,798,484 | 52,629 | 157,412 | 494,108 | 2.99 | 146.6 |
| C-8 | 3,914,400 | 18,057 | 116,170 | 570,848 | 6.43 | 143.9 |
| C-9 | 3,931,500 | 28,762 | 152,087 | 646,646 | 5.29 | 145.8 |
| C-10 | 4,448,471 | 34,553 | 155,815 | 665,846 | 4.51 | 145.8 |
| C-11 | 2,644,800 | 48,560 | 169,007 | 624,200 | 3.48 | 147.0 |
| C-12 | 5,332,235 | 51,771 | 409,655 | 1,643,708 | 7.91 | 147.1 |
| C-13 | 4,701,818 | 73,251 | 422,884 | 1,794,768 | 5.77 | 147.1 |
| C-14 | 9,943,200 | 79,137 | 427,915 | 1,704,507 | 5.41 | 148.3 |
| C-15 | 3,589,895 | 41,269 | 157,755 | 608,816 | 3.82 | 147.6 |
| C-16 | 3,843,429 | 20,519 | 118,735 | 547,511 | 5.79 | 145.6 |
| C-17 | 7,374,000 | 31,384 | 149,968 | 649,731 | 4.78 | 146.6 |
| C-18 | 2,069,268 | 142,243 | 528,329 | 1,786,121 | 3.71 | 148.8 |
| C-19 | 4,201,200 | 146,842 | 583,343 | 2,112,818 | 3.97 | 149.3 |
| C-20 | 3,074,182 | 153,727 | 515,347 | 1,774,716 | 3.35 | 148.6 |
| C-21 | 2,345,000 | 63,491 | 180,083 | 621,548 | 2.84 | 148.0 |
| C-22 | 2,682,545 | 54,833 | 161,679 | 531,840 | 2.95 | 147.3 |
| C-23 | 2,225,032 | 47,288 | 169,722 | 733,298 | 3.59 | 148.0 |

TABLE 3
¹³C NMR characterization of select polypropylene examples.
All defects are reported as defects per 10,000 monomer units. No 2,1-regio (te)
defects were observed.

| | Cat | Activator | | | | | | | mmrm + |
|---|---|---|---|---|---|---|---|---|---|
| Ex# | ID | ID | m | r | mmmm | mmmr | rmmr | mmrr | rmrr |
| 2 | 3 | A | 0.988 | 0.012 | 0.967 | 0.007 | 0.008 | 0.005 | 0.004 |
| 5 | 3 | A | 0.982 | 0.018 | 0.953 | 0.010 | 0.010 | 0.008 | 0.008 |
| 8 | 3 | B | 0.985 | 0.015 | 0.962 | 0.007 | 0.009 | 0.004 | 0.007 |
| 11 | 3 | B | 0.985 | 0.015 | 0.963 | 0.008 | 0.007 | 0.005 | 0.008 |
| 15 | 4 | A | 0.987 | 0.013 | 0.962 | 0.009 | 0.007 | 0.008 | 0.007 |
| 17 | 4 | A | 0.982 | 0.018 | 0.955 | 0.010 | 0.005 | 0.010 | 0.011 |
| 20 | 4 | B | 0.992 | 0.008 | 0.978 | 0.005 | 0.003 | 0.006 | 0.003 |
| 23 | 4 | B | 0.987 | 0.013 | 0.967 | 0.007 | 0.005 | 0.009 | 0.005 |
| 26 | 5 | A | 0.991 | 0.009 | 0.974 | 0.007 | 0.004 | 0.007 | 0.003 |
| 29 | 5 | A | 0.981 | 0.019 | 0.955 | 0.010 | 0.006 | 0.010 | 0.009 |
| 33 | 5 | B | 0.986 | 0.014 | 0.965 | 0.007 | 0.006 | 0.008 | 0.006 |
| 35 | 5 | B | 0.985 | 0.015 | 0.963 | 0.007 | 0.005 | 0.008 | 0.007 |
| 38 | 6 | A | 0.982 | 0.018 | 0.956 | 0.007 | 0.009 | 0.010 | 0.007 |
| 42 | 6 | A | 0.971 | 0.029 | 0.942 | 0.009 | 0.007 | 0.014 | 0.010 |
| 44 | 6 | B | 0.986 | 0.014 | 0.966 | 0.006 | 0.007 | 0.008 | 0.005 |
| 48 | 6 | B | 0.985 | 0.015 | 0.965 | 0.007 | 0.005 | 0.009 | 0.006 |
| C-3 | 1 | A | 0.988 | 0.012 | 0.968 | 0.010 | 0.004 | 0.008 | 0.004 |
| C-4 | 1 | A | 0.987 | 0.013 | 0.964 | 0.008 | 0.006 | 0.010 | 0.004 |
| C-8 | 1 | A | 0.977 | 0.023 | 0.941 | 0.013 | 0.011 | 0.013 | 0.007 |
| C-9 | 1 | A | 0.979 | 0.021 | 0.953 | 0.008 | 0.007 | 0.011 | 0.006 |
| C-14 | 2 | A | 0.980 | 0.020 | 0.957 | 0.008 | 0.005 | 0.011 | 0.007 |
| C-17 | 2 | A | 0.970 | 0.030 | 0.935 | 0.011 | 0.009 | 0.014 | 0.011 |
| C-19 | 2 | B | 0.988 | 0.012 | 0.970 | 0.007 | 0.004 | 0.009 | 0.004 |
| C-22 | 2 | B | 0.982 | 0.018 | 0.957 | 0.009 | 0.006 | 0.011 | 0.006 |

| | | | | | | 2,1-regio | 2,1-regio | |
|---|---|---|---|---|---|---|---|---|
| | | | | | stereo | (ee) | (et) | 1,3-regio |
| Ex# | rmrm | rrrr | mrrr | mrrm | defects | defects | defects | defects |
| 2 | 0.001 | 0.001 | 0.002 | 0.004 | 53.7 | 70.3 | 9.3 | 0 |
| 5 | 0.002 | 0.001 | 0.003 | 0.005 | 87.8 | 75.3 | 12.5 | 0 |
| 8 | 0.002 | 0.001 | 0.003 | 0.004 | 66.7 | 70.3 | 11.6 | 0 |
| 11 | 0.001 | 0.001 | 0.002 | 0.004 | 70.3 | 77.7 | 13.4 | 0 |
| 15 | 0.003 | 0.000 | 0.001 | 0.003 | 85.4 | 55.3 | 8.0 | 0 |
| 17 | 0.002 | 0.000 | 0.002 | 0.004 | 110.9 | 60.4 | 8.2 | 0 |
| 20 | 0.001 | 0.000 | 0.000 | 0.003 | 48.8 | 57.4 | 7.8 | 0 |
| 23 | 0.002 | 0.001 | 0.001 | 0.004 | 74.5 | 61.9 | 8.5 | 0 |
| 26 | 0.001 | 0.000 | 0.000 | 0.003 | 55.6 | 58.6 | 8.4 | 0 |
| 29 | 0.003 | 0.001 | 0.002 | 0.005 | 105.2 | 57.7 | 7.3 | 0 |
| 33 | 0.003 | 0.001 | 0.001 | 0.004 | 80.2 | 56.3 | 7.9 | 0 |
| 35 | 0.002 | 0.001 | 0.001 | 0.004 | 87.6 | 63.6 | 8.8 | 0 |
| 38 | 0.004 | 0.001 | 0.001 | 0.005 | 103.9 | 52.3 | 6.8 | 0 |
| 42 | 0.004 | 0.002 | 0.006 | 0.007 | 135.7 | 59.4 | 11.4 | 0 |
| 44 | 0.002 | 0.001 | 0.001 | 0.004 | 72.9 | 55.2 | 7.4 | 0 |
| 48 | 0.002 | 0.001 | 0.001 | 0.005 | 82.0 | 64.2 | 8.8 | 0 |
| C-3 | 0.001 | 0.001 | 0.001 | 0.004 | 62.4 | 68.4 | 10.2 | 2.9 |
| C-4 | 0.002 | 0.000 | 0.001 | 0.004 | 78.0 | 64.9 | 9.1 | 3.8 |
| C-8 | 0.005 | 0.002 | 0.002 | 0.007 | 120.6 | 68.2 | 10.7 | 11.5 |
| C-9 | 0.003 | 0.002 | 0.002 | 0.007 | 100.5 | 66.5 | 11.0 | 0 |
| C-14 | 0.003 | 0.001 | 0.002 | 0.006 | 99.4 | 64.7 | 8.9 | 0 |
| C-17 | 0.006 | 0.002 | 0.003 | 0.009 | 153.5 | 63.0 | 10.8 | 0 |
| C-19 | 0.002 | 0.000 | 0.001 | 0.004 | 71.6 | 59.9 | 8.0 | 0 |
| C-22 | 0.003 | 0.001 | 0.001 | 0.006 | 96.2 | 65.9 | 9.0 | 0 |

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. All numerical values are “about” or “approximately” the indicated value, and take into account experimental error and variations that would be expected by a person having ordinary skill in the art. Any of the values in the tables can provide the end points for ranges that define their respective measurement or property, with an additional +/−10%.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby.

While the present disclosure has been described with respect to a number of embodiments and examples, those skilled in the art, having benefit of this disclosure, will appreciate that other embodiments can be devised which do not depart from the scope and spirit of the present disclosure.

1. A catalyst compound represented by Formula (I): 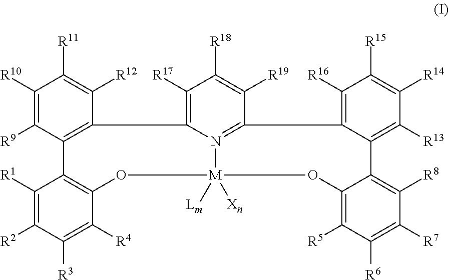
wherein:
M is a group 3, 4, or 5 metal;
L is a Lewis base;
X is an anionic ligand;
n is 1, 2, or 3;
m is 0, 1, or 2;
n+m is not greater than 4;
each of R¹⁰ and R¹⁴ is independently C₄-C₄₀ hydrocarbyl or OR²⁰, where R²⁰ is a C₄-C₄₀ hydrocarbyl;
each of R¹, R², R³, R⁴, R⁵, R⁶, R⁷, and R⁸ is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms; each of R⁹, R¹¹, and R¹² is independently hydrogen, C₁-C₄₀ hydrocarbyl, C₁-C₄₀ substituted hydrocarbyl, a heteroatom or a heteroatom-containing group, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹³, R¹⁵, and R¹⁶ is independently hydrogen, C₁-C₄₀ hydrocarbyl, C₁-C₄₀ substituted hydrocarbyl, a heteroatom or a heteroatom-containing group, or R¹⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₄₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups may be joined together to form a bidentate Lewis base;
an X group may be joined to an L group to form a monoanionic bidentate group; and
any two X groups may be joined together to form a dianionic ligand group.

2. The catalyst compound of claim 1, wherein R⁴ and R⁵ are each independently adamantanyl, R² and R⁷ are each independently a C₄-C₄₀ hydrocarbyl, and R¹⁰ and R¹⁴ are each independently OR²⁰, where R²⁰ is a C₄-C₁₂ hydrocarbyl.

3. The catalyst compound of claim 1, wherein the R², R⁷, R¹⁰ and R¹⁴ substituents have a total carbon atom count of 12 carbon atoms or greater.

4. The catalyst compound of claim 1, wherein the R², R⁷, R¹⁰ and R¹⁴ substituents have a total carbon atom count of 12 carbon atoms or greater, and R⁴ and R⁵ are selected from tert-butyl, adamantanyl and substituted adamantanyl.

5. The catalyst compound of claim 1, wherein the R², R⁷, R⁴, R⁵, R¹⁰ and R¹⁴ substituents having a total carbon atom count of 32 carbon atoms or greater.

6. The catalyst compound of claim 1, wherein the catalyst compound is one of the following:

| | |
|---|---|
| 3. | 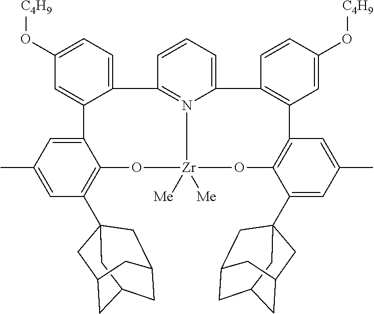 |
| 4. | 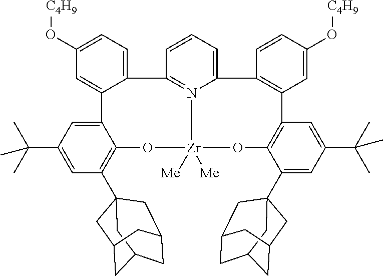 |
| 5. | 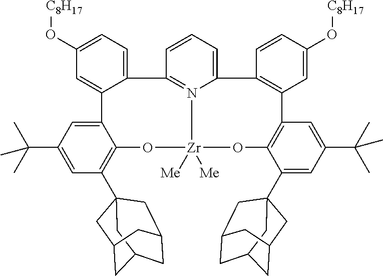 |
| 6. | 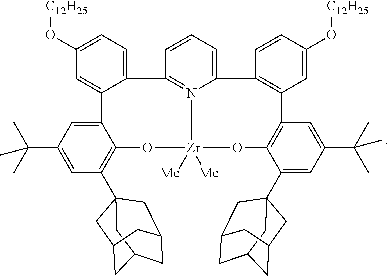 |

7. The catalyst compound of claim 1, wherein each of R¹⁰ and R¹⁴ is independently OR²⁰, where R²⁰ is a C₄-C₄₀ hydrocarbyl.

8. A catalyst system comprising an activator, and optionally a support material, and the catalyst compound of claim 1.

9. A homogeneous solution, comprising:
an aliphatic hydrocarbon solvent; and
at least one complex of Formula (I), with a concentration of the complex being 0.15 wt % or greater.

10. The homogeneous solution of claim 9 wherein the aliphatic hydrocarbon solvent is isohexane, cyclohexane, methylcyclohexane, pentane, isopentane, heptane, an isoparaffin solvent, a non-aromatic cyclic solvent, or combinations thereof.

11. A process for the production of a propylene based polymer comprising: polymerizing propylene by contacting the propylene with a catalyst system of claim 8, in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

12. A process for the production of an ethylene based polymer comprising: polymerizing ethylene by contacting the ethylene with the catalyst system of claim 8, in one or more continuous stirred tank reactors or loop reactors, in series or in parallel, at a reactor pressure of from 0.05 MPa to 1,500 MPa and a reactor temperature of from 30° C. to 230° C. to form an ethylene based polymer.

13. The process of claim 11 wherein the catalyst compound and the activator are fed into the reactor(s) separately.

14. The process of claim 11 wherein the catalyst compound and the activator are pre-mixed prior to being fed into the reactor(s).
